(19) United States
(12) Patent Application Publication
(10) Pub. No.: US 2024/0288645 A1
(43) Pub. Date: Aug. 29, 2024

(54) HIGH FIBER DENSITY OPTICAL FIBER CABLE

(71) Applicant: CORNING RESEARCH & DEVELOPMENT CORPORATION, Corning, NY (US)

(72) Inventors: Bradley Jerome Blazer, Granite Falls, NC (US); Warren Welborn McAlpine, Hickory, NC (US); Christopher Mark Quinn, Hickory, NC (US); David Alan Seddon, Hickory, NC (US); Pushkar Tandon, Painted Post, NY (US); Kenneth Darrell Temple, JR., Newton, NC (US)

(21) Appl. No.: 18/648,958

(22) Filed: Apr. 29, 2024

Related U.S. Application Data
(63) Continuation of application No. PCT/US2022/048972, filed on Nov. 4, 2022.
(60) Provisional application No. 63/276,014, filed on Nov. 5, 2021.

(51) Int. Cl. G02B 6/44

(52) U.S. Cl. CPC G02B 6/443

(57) ABSTRACT

Provided are embodiments of an optical fiber cable. The optical fiber cable includes a cable jacket with an inner surface and an outer surface in which the inner surface defines a central cable bore and in which the outer surface defines an outermost surface of the optical fiber cable. The optical fiber cable includes from 48 to 864 optical fibers disposed within the central cable bore. Further, the outer surface of the cable jacket defines a cable diameter of at least 2 mm and up to 11 mm. The optical fiber cable has a fiber density of at least 7.5 optical fibers/mm² based on a cross-sectional area of the optical fiber cable as measured from the outer surface of the cable jacket.

### PRIORITY APPLICATION

This application is a continuation of International Patent Application No. PCT/US2022/048972, filed Nov. 4, 2022, which claims the benefit of priority of U.S. Provisional Application No. 63/276,014, filed on Nov. 5, 2021, the content of which is relied upon and incorporated herein by reference in its entirety.

### BACKGROUND OF THE DISCLOSURE

The present disclosure generally relates to optical fiber cables and in particular to optical fiber cables having a high density of optical fibers and minimized free space.

In general, an optical fiber cable needs to carry more optical fibers in order to transmit more optical data, and in order to carry more optical fibers, the size of the optical fiber cable needs to be increased. The increased size is at least partially the result of free space considerations to avoid macro- and micro-bending attenuation losses. For existing installations, size limitations and duct congestion limit the size of optical fiber cables that can be used without the requirement for significant retrofitting. Thus, it may be desirable to provide optical fiber cables having a higher fiber density (i.e., more fibers per cross-sectional area of the cable) without increasing the cable diameter such that the high fiber density cables can be used in existing ducts.

### SUMMARY OF THE DISCLOSURE

In one aspect, embodiments of the present disclosure relate to an optical fiber cable. The optical fiber cable includes a cable jacket having an inner surface and an outer surface. The inner surface defines a central cable bore, and the outer surface defines an outermost surface of the optical fiber cable. The cable outer diameter is 11 mm or less. The optical fiber cable also includes a cable core disposed in the central cable bore. The cable core has a cross-sectional area and a plurality of optical fibers provided in the core, each of the plurality of optical fibers having an outer diameter of less than or equal to 210 microns, preferably less than or equal to 200 microns. The plurality of optical fibers fill at least 40% of the cross-sectional area of the cable core, and the cable comprises at least 48 optical fibers and a fiber density based on cable outer cross-sectional area that is at least 7.5 fibers/mm². The plurality of optical fibers has a mode field diameter at 1310 nm of between 8.2 microns and 9.5 microns, a cable cutoff less than 1260 nm, a zero-dispersion wavelength between 1300 nm and 1324 nm. The plurality of optical fibers exhibit an attenuation increase of less than 0.15 dB/km at 1550 nm at −10° C., preferably an attenuation increase of less than 0.15 dB/km at 1550 nm at −30° C. as measured by IEC 60794-5-10:2014.

In another aspect, embodiments of the present disclosure relate to a lumen. The lumen includes a plurality of optical fibers in which each of the plurality of optical fibers has an outer diameter of 210 microns or less, preferably 200 microns or less. The lumen further includes a membrane surrounding the plurality of optical fibers. The membrane may be made of any suitable material, including a polypropylene, a polyester, a polyethylene, a polyamide, a polyvinyl chloride (PVC), or a polytetrafluoroethylene material, and may include small quantities of other materials or fillers that provide different properties to the material of the membrane, such other materials including material that provides for easy access by tearing of the membrane (e.g., tearing by hand), coloring, UV/light blocking (e.g., carbon black), or fire resistance/flame retardancy. A thickness of the membrane is 50 microns or less, and a free space within the membrane is 60% or less.

In a further aspect, embodiments of the present disclosure relate to an optical fiber cable. The optical fiber cable includes a cable jacket having an inner surface and an outer surface. The inner surface defines a central cable bore, and the outer surface defines an outermost surface of the optical fiber cable. The optical fiber cable also includes a cable core disposed within the central bore of the cable jacket. The cable core includes a plurality of optical fibers. The cable core includes a plurality of elements that may be SZ-stranded, unidirectionally stranded, or not stranded at all. In the case of a cable having no strength elements, the cable core is able to withstand a tensile load greater than a weight of one kilometer of the optical fiber cable, and the plurality of optical fibers comprise a cumulative tensile rigidity of at least 75% of the optical fiber cable at 0.1% core strain.

In still another aspect, embodiments of the present disclosure relate to an optical fiber cable. The optical fiber cable includes a cable jacket having an inner surface and an outer surface. The inner surface defines a central cable bore, and the outer surface defines an outermost surface of the optical fiber cable. The optical fiber cable also includes a cable core disposed within the central bore of the cable jacket. The cable core includes two or more lumens. Each lumen includes a plurality of optical fibers in which each of the plurality of optical fibers has an outer diameter of 210 microns or less, preferably 200 microns or less. Each lumen also includes a membrane surrounding the plurality of optical fibers in which the membrane has a thickness of 50 microns or less. In the case of a cable without any strength elements, the plurality of optical fibers have a cumulative tensile rigidity that is at least 75% of a tensile rigidity of the optical fiber cable.

In yet another aspect, embodiments of the present disclosure relate to an optical fiber cable. The optical fiber cable includes a cable jacket having an inner surface and an outer surface. The inner surface defines a central cable bore, and the outer surface defines an outermost surface of the optical fiber cable. The optical fiber cable also includes a plurality of optical fibers disposed within the central cable core. A plurality of optical fibers may be encased in a membrane material to form a lumen, and a plurality of lumens may be provided in the cable core to form a lumen bundle. The cable may include strength elements that may be embedded in the cable jacket or provided between the lumen bundle and the cable jacket. In accordance with yet other aspects, an armor layer, such as a two-piece armor layer, may be provided to surrounded the lumen bundle between the lumen bundle and the cable jacket. In addition, a protective layer of foamed material or another suitable material may be provided between the lumen bundle and the armor or cable jacket to provide additional protection to the optical fibers in the lumens.

In still yet another aspect, embodiments of the present disclosure relate to an optical fiber cable. The optical fiber cable includes a cable jacket having an inner surface and an outer surface in which the inner surface defines a central cable bore and in which the outer surface defines an outermost surface of the optical fiber cable. The optical fiber cable also includes from 48 to 864 optical fibers disposed within the central cable bore. The outer surface of the cable jacket defines a cable diameter of at least 2 mm and up to 11 mm. The optical fiber cable may have a fiber density of at least 7.5 optical fibers per mm² based on a cross-sectional area of the optical fiber cable as measured from the outer surface of the cable jacket. In accordance with some aspects of the present disclosure, the optical fiber cable does not include a strength member. In accordance with yet other aspects of the present disclosure, the optical fiber cable may include one or more strength members.

In still a further aspect, embodiments of the present disclosure relate to an optical fiber cable. The optical fiber cable includes a cable jacket having an inner surface and an outer surface in which the inner surface defines a central cable bore extending along a longitudinal axis of the optical fiber cable and in which the outer surface defines an outermost surface of the optical fiber cable. The optical fiber cable also includes a plurality of lumens disposed within the central cable bore. Each lumen of the plurality of lumens includes at least two optical fibers surrounded by a membrane. The membrane of each lumen has a thickness of 50 microns or less. The membrane is reconfigurable between a plurality of shapes, and the plurality of shapes is defined by a perimeter of the membrane as viewed from a cross-section of the lumen taken perpendicular to the longitudinal axis. The plurality of lumens is arranged in at least a first layer and a second layer within the central cable bore. The second layer is in contact and surrounds the first layer, and a shape of at least one lumen in the first layer is different from a shape of at least one lumen in the second layer.

In accordance with yet other aspects of the present disclosure, the membrane may be drawn down tight onto the plurality of optical fibers such that the membrane is more static in shape to maintain the smallest cross-sectional area of the plurality of fibers. Each lumen in this configuration maintains a similar shape to each other lumen in the core regardless of the position or layer of the lumen in the core.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the claims. The accompanying drawings are included to provide a further understanding and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 depicts a perspective view of a high fiber density optical fiber cable, according to exemplary embodiments;

FIG. 2 depicts a cross-sectional view of the optical fiber cable depicted in FIG. 1, according to exemplary embodiments;

FIG. 3 depicts optical fibers stranded into bundles that are stranded into larger groupings, according to exemplary embodiments;

FIGS. 4A-4C depict lumens including a membrane surrounding a plurality of optical fibers, according to exemplary embodiments;

FIG. 5 depicts an optical fiber cable including multi-lumens surrounding a plurality of lumens, according to an exemplary embodiment;

FIGS. 6A-6D depict various configurations of markings used on the optical fiber cable and the lumens used at least in part for the purpose of identification, according to exemplary embodiments;

FIGS. 7A-7G depict example shapes of lumens, according to exemplary embodiments;

FIGS. 8A and 8B depict examples of optical fiber cable cores including a plurality of lumens having reconfigurable shapes, according to exemplary embodiments;

FIGS. 9A, 9B and 9C depict graphs of the outer diameter of an optical fiber cable as a function of the number of optical fibers and the free space within the optical fiber cable, according to exemplary embodiments;

FIG. 10 depicts a graph of jetting distance for optical fiber cables having various degrees of coupling to the cable jacket, according to exemplary embodiments;

FIG. 11 is a micrograph of a spherical powder that can be used in the cable core of the optical fiber cable, according to exemplary embodiments;

FIG. 12 depicts a graph of the circle diameter for a cable core as a function of freespace and fiber outer diameter for cable cores having 96 optical fibers, according to exemplary embodiments;

FIG. 13A depicts a cross-sectional view of an optical fiber cable similar to aspects of the cable depicted in FIG. 1 and including strength elements, according to an exemplary embodiment;

FIG. 13B depicts a cross-sectional view of an optical fiber cable similar in aspects of the cable depicted in FIG. 13A and including additional features such as an armor layer and a protective layer, according to exemplary embodiments;

FIG. 14 is an end view of an optical fiber configured for use in a high density optical fiber cable, according to an exemplary embodiment;

FIG. 15 is a graph illustrating the refractive index design profile of an optical fiber of FIG. 14 having a rectangular trench, according to an exemplary embodiment; and

FIG. 16 is a graph illustrating the refractive index design profile of an optical fiber of FIG. 15 having a triangular trench, according to an exemplary embodiment.

### DETAILED DESCRIPTION

Embodiments of the present disclosure relate to a high-density optical fiber cable. In one or more embodiments, the optical fibers are provided in reconfigurable lumens having a thin membrane so that the lumens can be tightly packed within the cable core. As will be discussed more fully below, some embodiments of the optical fiber cable are configured to eliminate strength members, such as glass-reinforced plastic rods, metal wires, and tensile strands, by eliminating free space around the optical fibers so that the optical fibers together act as the strength member of the optical fiber cable. In such embodiments without strength members, the optical fibers may account for 75% or more of the tensile rigidity of the optical fiber cable. Advantageously, an optical fiber cable having these characteristics combines a high fiber density with a small diameter and the requisite properties for jetting the cable through ducts. In a particular example disclosed herein, the optical fiber cable includes 288 optical fibers in a cable jacket having an outer diameter small enough to jet at least 1500 m in an 8 mm duct. Examples of other high fiber density optical fiber cables include from 48 to 864 optical fibers that do and do not include strength elements are also provided herein.

The following detailed description represents embodiments that are intended to provide an overview or framework for understanding the nature and character of the claims. The accompanied drawings are included to provide a further understanding of the claims and constitute a part of the specification. The drawings illustrate various embodiments, and together with the descriptions serve to explain the principles and operations of these embodiments as claimed.

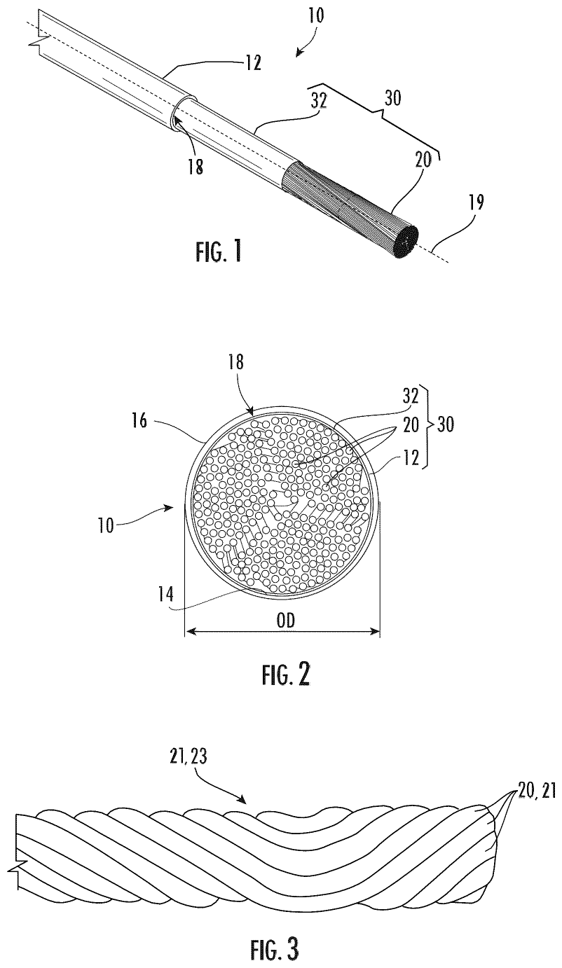

FIG. 1 depicts an example embodiment of an optical fiber cable 10 according to the present disclosure and shown in perspective view, and FIG. 2 depicts a cross-sectional view of the optical fiber cable 10 perpendicular to a longitudinal axis 19 of the optical fiber cable 10. The optical fiber cable 10 includes a cable jacket 12 having an inner surface 14 and an outer surface 16. The inner surface 14 of the optical fiber cable 10 defines a central bore 18 that extends along the longitudinal axis 19 of the optical fiber cable 10. Disposed within the central bore 18 of the optical fiber cable 10 is cable core 30 including a plurality of optical fibers 20. In embodiments with no additional strength elements, the optical fibers 20 act as the primary strength element of the cable core 30. That is, the cable core 30 does not include any additional strength elements, such as glass reinforced plastic rods, steel wires, or tensile strands (e.g., aramid or glass yarns). Instead, the optical fibers 20 are grouped, stranded, or grouped and stranded within the cable core 30 at a high fiber density and with a relatively low free space, which causes the optical fibers 20 to act as a strength element within the cable core 30.

FIG. 2 depicts example embodiment of the optical fiber cable 10 in which the optical fiber cable 10 includes 288 optical fibers 20 with each optical fiber 20 having an outer diameter of about 196 microns (in particular, the optical fiber 20 is constructed from a bare fiber having an outer diameter of about 188 microns that is provided with a color coating that extends the outer diameter to about 196 microns, and the outer diameter is measured at this outer surface of the color coating). The exemplary embodiment of the optical fiber cable 10 shown in FIG. 2 has an outer diameter OD of 5.7 mm as measured at the outer surface 16 according to the formula

$$OD = \sqrt{\frac{4 A}{π}} ,$$

with A being the cross-sectional area of the optical fiber cable 10. The optical fiber cable 10 had a weight of 28 kg/km. The fiber density in the optical fiber cable 10 is 11.2 fibers per mm² (based on cable cross-sectional area A) and the fiber free space of loose fibers inside the cable core is 25%. The cable is rated for 1000 N at 0.4% fiber strain (or 3.6× cable weight).

In one or more embodiments, the optical fibers 20 of the optical fiber cable 10 are stranded as shown in FIG. 3. For example, all of the optical fibers 20 may be stranded (e.g., S or Z helically stranded or SZ-stranded) to form a first group 21 of stranded optical fibers 20. In one or more embodiments, the optical fibers 20 are SZ stranded as shown in FIG. 3. Further, for example, the first groups 21 of stranded optical fibers 20 may be stranded to form a larger second group 23 of stranded first groups 21. In one or more embodiments, the first groups 21 are SZ stranded to form the second group 23. In one or more embodiments, the first group 21 may contain all of the optical fibers 20 of the cable core 30. In one or more other embodiments, each first group 21 may include, e.g., from eight to twenty-four optical fibers 20, and from eight to twenty-four first groups 21 may be stranded together to form second group 23. Although shown in FIG. 3 in a certain stranded configuration, the optical fibers 20 may also be provided in a substantially parallel configuration (i.e., not stranded) and/or the first groups 21 may also be provided in a substantially parallel configuration (i.e., not stranded). The plurality of first groups 21 and/or the stranded first groups 21 forming the second group 23 form a lumen bundle.

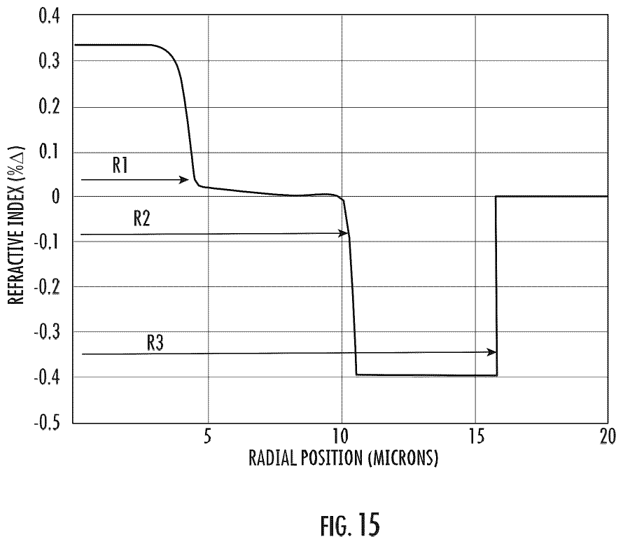

Thus, in one or more embodiments, the optical fiber cable 10 may consist essentially of the cable jacket 12 surrounding a plurality of first groups 21 of optical fibers 20, that may or may not be arranged into larger second groups 23. Other components that do not affect the basic and novel characteristics of the optical fiber cable 10 that may be included are, for example, a binder film 32 provided between the plurality of first groups 21 or second groups 23 and the cable jacket 12, water blocking material (e.g., tapes and powders, including powders made of super absorbent polymers (SAP)), lubricants, friction-enhancing materials, and access features (e.g., ripcords or preferential tear features, such as a strip of dissimilar polymer in the cable jacket 12). In one or more embodiments, armor layers and strength elements are excluded from the construction of the optical fiber cable 10, while in other embodiments, such as shown in FIGS. 13 and 14, optical fiber cables 10 may further include an armor layer 42 and a protective layer 44 to provide additional protection to the fibers 20 in the fiber bundle 30.

In order to provide a level of organization of the optical fibers 20 within the optical fiber cable 10, the optical fibers 20 may include an outer coating layer. Optical fibers 20 within first groups 21 or second groups 23 may include optical fibers 20 having the following sequence of twelve color coatings: blue, orange, green, brown, slate, white, red, black, yellow, violet, rose, and aqua. That is, within one first group 21, there will be only one optical fiber 20 having a blue color coating, only one optical fiber 20 having an orange color coating, one optical fiber 20 having a green color coating, etc. For first groups 21 having more than twelve optical fibers 20, the color sequence can be repeated but the color coating may further include a stripe along the length of the optical fiber 20. For all of the color coatings except for black, the stripe may be a black stripe, and for the black color coating, the stripe may be, e.g., a white, yellow, or gray. Thus, despite the large number of loose optical fibers within the optical fiber cable 10, the coloring of the outer layer of the optical fibers 20 along with the grouping and/or stranding of the optical fibers 20 into groups 21, 23 allows for differentiation of the optical fibers 20. Further, the groups 21, 23 of the optical fibers 20 can be differentiated from other groups 21, 23 of optical fibers 20 by providing colored banding, tape, or wrap. For example, each first group 21 may include a periodically spaced band, tape, or wrap along the length of the stranded optical fibers 20. In this way, a particular first group 21 may be identified by the particular striped or unstriped blue, orange, green, brown, slate, white, red, black, yellow, violet, rose, or aqua band along its length. While one common color-coding scheme for twelve optical fibers was discussed for the purposes of illustration, other color-coding schemes used for fewer or greater than twelve optical fibers may also be used without departing from the scope of the present disclosure.

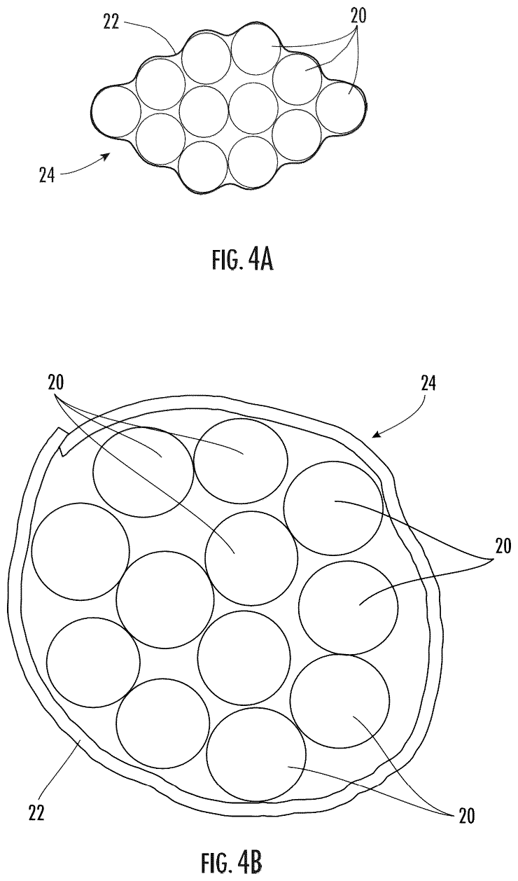

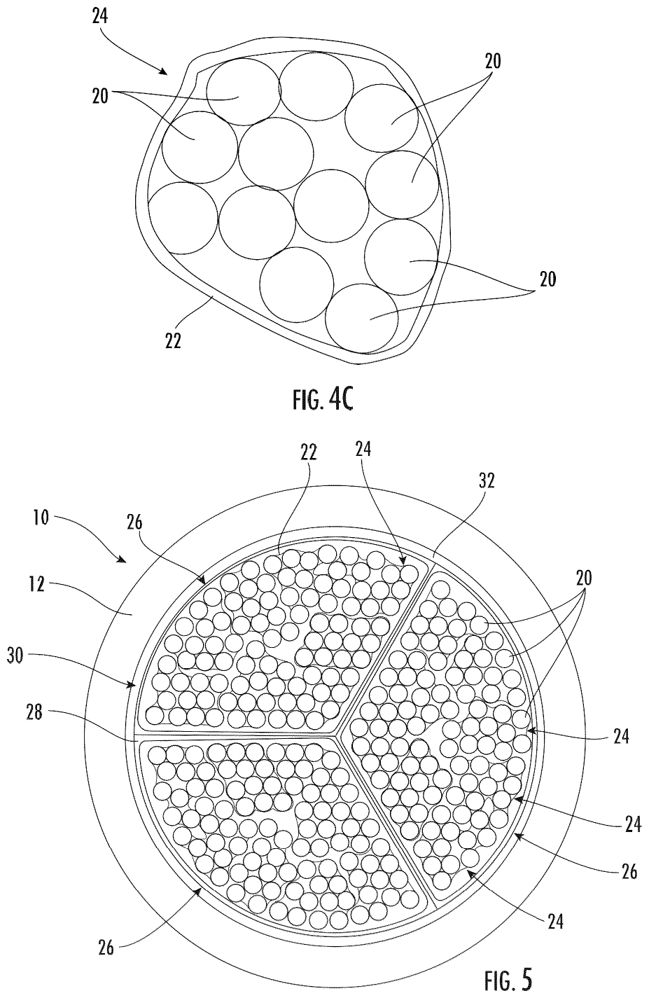

In one or more embodiments, the optical fibers 20 are arranged in groups and enclosed within a thin membrane 22 to form a lumen 24. FIGS. 4A-4C depict examples of a membrane 22 grouping the optical fibers 20 into a lumen 24. As can be seen in FIGS. 4A-4C, the membrane 22 may be provided tightly around the optical fibers 20 such that the lumen 24 comprises a low free space within the membrane 22. In one or more embodiments, the lumen 24 comprises a free space of 50% or less, 40% or less, 30% or less, or 25% or less. In one or more embodiments, the free space may be 20% or more. In the lumen 24 depicted in FIG. 4C, the free space was calculated to be approximately 26%. In certain embodiments, where the free space is limited, the tight binding of the optical fibers 20 within the membrane 22 causes the lumen 24 to act as a composite strength member so that a conventional strength member, such as a glass-reinforced plastic (GRP) rod, metal wire, or tensile strands, may not be needed in the cable core 30 or the optical fiber cable 10 at all.

In one or more embodiments, the thickness of the membrane 22 is 50 microns or less, 40 microns or less, or 30 microns or less, in particular between 10 microns and 50 microns. In one or more embodiments, the membrane 22 groups from two to ninety-six in particular from eight to thirty-six, and particularly from twelve to twenty-four, optical fibers 20 into a lumen 24. As discussed above, the optical fibers 20 within the lumen 24 may be provided in a color-coded sequence of striped or unstriped coatings of blue, orange, green, brown, slate, white, red, black, yellow, violet, rose, and aqua, or other indicia stripes, ring marking, tally marks, or combinations of such fiber identification schema.

As shown in FIG. 4A and as will be discussed more fully below, the membrane 22 is reconfigurable such that the shape of the lumen 24 can change depending on the available space within the optical fiber cable 10. In one or more embodiments, such as shown in FIG. 4A, the membrane 22 may tightly conform to the curvature of the optical fibers 20 and, in embodiments, into the interstitial spaces between the optical fibers 20. In one or more other embodiments, such as depicted in FIGS. 4B and 4C, the membrane 22 does not conform to the outer surface of the optical fibers 20 and may be more circular in shape, for example. The lumen 24 created by the optical fibers 20 enveloped in the membrane 22 provides strength for tensile axial loading.

In one or more embodiments, the grouping of the optical fibers 20 by the membrane 22 into lumens 24 allows for the optical fiber cable 10 to be constructed without any conventional strength members. In other embodiments, conventional strength members 40 may be provided (see, e.g., FIGS. 13 and 14). As used herein, conventional strength members include GRP or metal rods or fiber strands extending along the center of the cable 10 or embedded in the cable jacket 12. Thus, in one or more embodiments, the optical fiber cable 10 may consist essentially of the cable jacket 12 surrounding a plurality of lumens 24. Other components that do not affect the basic and novel characteristics of the optical fiber cable 10 that may be included are, for example, a binder film provided between the plurality of lumens 24 and the cable jacket 12, water blocking material (e.g., tapes and powders), lubricants, friction-enhancing materials, and access features (e.g., ripcords or preferential tear features, such as a strip of dissimilar polymer in the cable jacket 12).

In one or more embodiments, an outer surface of the lumen 24 is frictionally coupled to the cable jacket 12. This frictional coupling helps to limit buckling of the optical fibers 20 within the optical fiber cable 10. In one or more embodiments, the frictional coupling between the lumens 24 and cable jacket 12 can be enhanced by pulling the cable jacket 12 around the lumens 24 during extrusion, which increases the normal force of the cable jacket 12 on the lumens 24, thereby increasing the friction between them. Alternatively or additionally, the frictional coupling between the lumens 24 and the cable jacket 12 can be enhanced by providing grease, gel, or a pressure sensitive adhesive at the interface between the lumens 24 and the cable jacket 12. In one or more embodiments, such friction enhancing materials can also be provided between the lumens 24 in the cable core 30.

In one or more embodiments, the lumens 24 are grouped together into multi-lumens 26 as shown in FIG. 5. In the example embodiment shown, eight twelve-fiber lumens 24 are grouped into a ninety-six fiber multi-lumen 26 and enveloped inside a membrane 28. In one or more embodiments, the membrane 28 of the multi-lumen 26 has a thickness between 10 microns and 50 microns. Further, in the example embodiment shown, three of the ninety-six fiber multi-lumens 26 are grouped to form a cable core 30.

In one or more embodiments, the cable core 30 may be further wrapped with a binder film 32. In one or more embodiments, the multi-lumens 26 are stranded (e.g., SZ, S, or Z stranded) within the cable core 30, and the binder film 32 may be used to hold the multi-lumens 26 in the stranded configuration. Thus, in one or more embodiments, the optical fiber cable 10 may consist essentially of the cable jacket 12 surrounding a plurality of lumens 24 grouped by membranes 28 into one or more multi-lumens 26. Other components that do not affect the basic and novel characteristics of the optical fiber cable 10 that may be included are, for example, the binder film 32 provided between the plurality of lumens 24 and the cable jacket 12, water blocking material (e.g., tapes and powders), lubricants, friction enhancing materials, and access features (e.g., ripcords or preferential tear features, such as a strip of dissimilar polymer in the cable jacket 12). In one or more embodiments, the multi-lumens 28 are frictionally coupled to the cable jacket 12 as described above.

In one or more embodiments, the membrane 28 includes from two to twenty-four, in particular from four to twelve lumens 24 to form multi-lumen 26. In one or more embodiments, the cable core 30 includes from two to ten, in particular from three to eight multi-lumens 26.

In one or more embodiments, the binder film 32 is a thin film jacket having a thickness between 40 microns and 150 microns, preferably less than 100 microns. A binder film 32 in this thickness range reduces the thermal load of the binder film 32 on the lumens 24 (or multi-lumens 26) during extrusion. That is, a thick binder layer could hold enough heat after extrusion to remelt the thin membranes 22, 28 of the lumens 24 and/or the multi-lumens 26 causing the lumens 24 or multi-lumens 26 to stick to the binder film 32 such that they become inseparable or difficult to separate. In accordance with yet other embodiments, the binder film 32 may be comprised of a material dissimilar to the material of the membranes 22, 28 of the lumens 24 or multi-lumens 26 such that when both materials reach their respective melting points, there is no bonding or limited bonding of either material to the other so that they remain easily separable.

In one or more embodiments, the cable jacket 12 has a thickness of between 0.5 mm and 1 mm. In particular embodiments, the cable jacket 12 has a thickness that is greater than 8% of the outer diameter of the optical fiber cable 10, such as between 8% and 10% of the outer diameter.

In one or more embodiments, the membranes 22, 28 are made from a polypropylene, a polyester, a polyethylene, a polyamide, a polyvinyl chloride (PVC), or a polytetrafluoroethylene material, amongst other possibilities, and may include small quantities of other materials or fillers that provide different properties to the material of the membrane, uch other materials including material that provides for easy access by tearing of the membrane (e.g., tearing by hand), coloring, UV/light blocking (e.g., carbon black), or fire resistance/flame retardancy Further, in embodiments, one or both of the membranes 22, 28 are substantially continuous around the optical fibers 20. In one or more embodiments, one or both of the membranes 22, 28 are discontinuous around the optical fibers 20. For example, one or both of the membranes 22, 28 may be a mesh material, may include cutouts, or may be in the form of a plurality of strips wrapped around the optical fibers 20.

In one or more embodiments, the cable jacket 12 is made from a polyethylene material (such as high density polyethylene (HDPE)), a nylon or polyamide, a low-smoke zero halogen (LSZH) polymer, a filled polyethylene, a flame retardant (FR) polymer, or a urethane polymer, amongst other possibilities.

In one or more embodiments, the binder film 32 is made from, e.g., linear low density polyethylene (LLDPE).

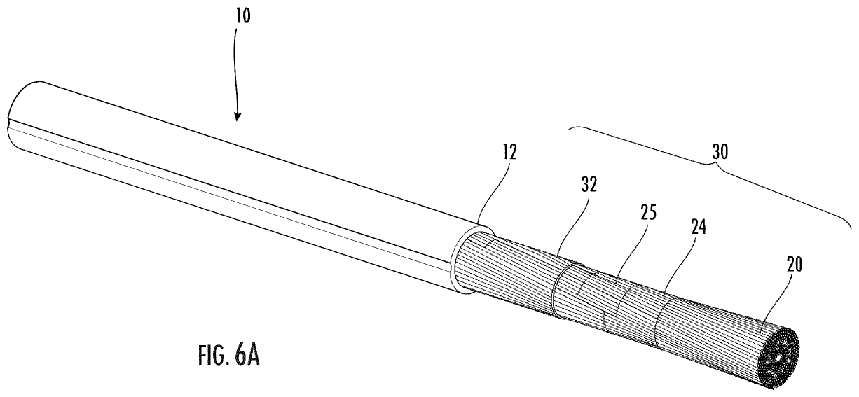

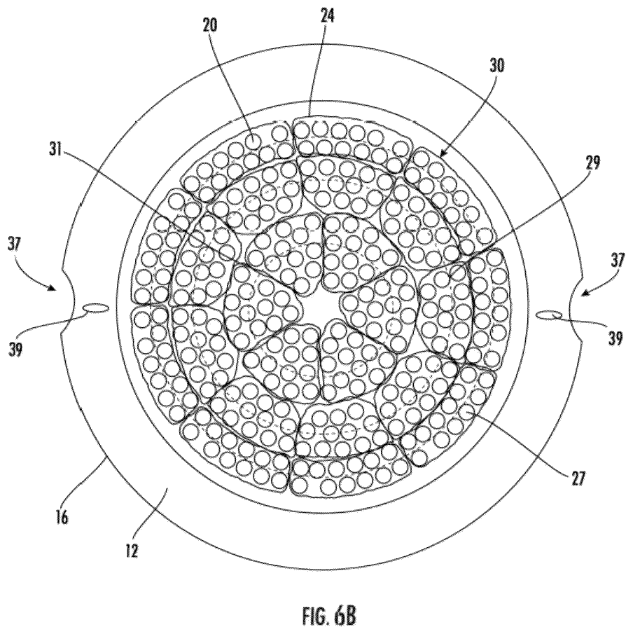

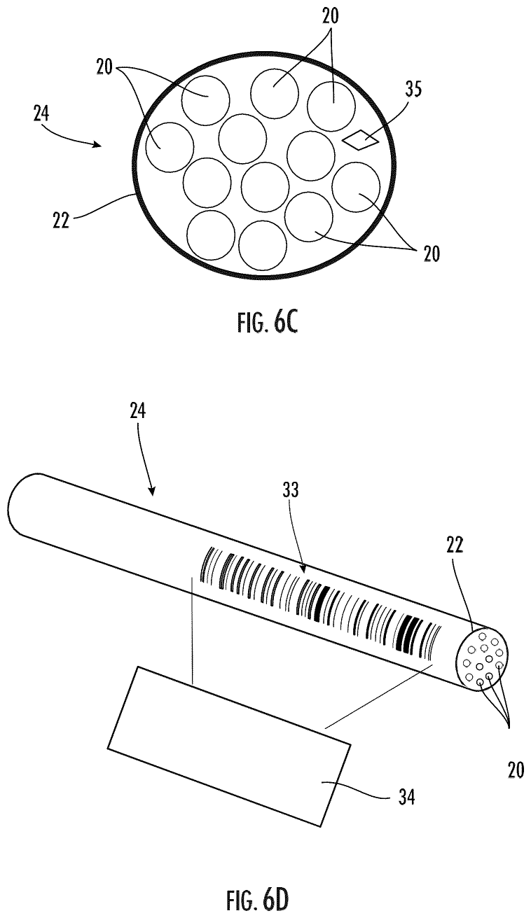

For organizational purposes, the lumens 24 according to embodiments of the present disclosure may be color-coded within the optical fiber cable 10. In particular, the cable core 30 may include a sequence of lumens 24 having membranes 22 of the following colors: blue, orange, green, brown, slate, white, red, black, yellow, violet, rose, and aqua. In one or more embodiments, the lumens 24 beyond the first twelve are also colored one of blue, orange, green, brown, slate, white, red, black, yellow, violet, rose, and aqua, but the membrane 22 may also be provided with a ring marking 25 as shown in FIG. 6A. Similar to the stripe on the optical fibers 20 discussed above, the ring marking 25 allows for repetition of the color-coding sequence while still providing readily apparent distinction between two blue membranes, two orange membranes, two green membranes, etc. Further, the particular color-coding sequence described is merely exemplary, and other color sequences can be used instead without departing from the scope of the present disclosure.

FIG. 6B depicts a cross-sectional view of the optical fiber cable 10 of FIG. 6A. From the cross-sectional view, it can be seen that the lumens 24 are arranged in layers within the cable bore 30. In one or more embodiments, the outermost layer 27 of lumens 24 comprises membranes 22 having a ring marking 25 (as shown in FIG. 6A). In one or more such embodiments, the middle layer 29 and inner layer 31 do not include ring markings 25.

FIG. 6B also depicts features of the cable jacket 12. In one or embodiments, the cable jacket 12 includes tactile locator features 37. In the embodiment depicted, the tactile locator features 37 comprise diametrically arranged depressions defined by the outer surface 16 of the cable jacket 12. However, in one or more other embodiments, the tactile locator features 37 comprise diametrically arranged bumps defined by the outer surface 16 of the cable jacket 12. The tactile locator features 37 assist a user in opening the cable by guiding the user to the location of access features 39. In the embodiment of the optical fiber cable 10, the access features 39 are strips of dissimilar polymer embedded in the polymer of the cable jacket 12. For example, the cable jacket 12 may substantially comprise polyethylene, and the dissimilar polymer of the access feature 39 may be polypropylene. The immiscibility of polyethylene cable jacket 12 and the polypropylene access features 39 prevents a strong bond from forming between the cable jacket 12 and the access features 39, allowing for a user to tear through the cable jacket 12 in the region of the access features 39. Further, once opened at the access features 39, the cable jacket 12 can be split along its length along the access features 39.

In one or more embodiments, each lumen 24 also includes a yarn 35 on the interior of the membrane 22 as shown in FIG. 6C. In embodiments, the yarn 35 provides one or more functions of identifying the lumen 24, water-blocking, or utilization as an access feature. In one or more such embodiments, the yarn 35 is colored according to the color-coding scheme described above. In this way, the yarn 35 can be used to provide identification of the lumen 24 in addition to the color of the membrane 22 or in place of the color of the membrane 22. In one or more such embodiments, the yarn 35 is impregnated or coated with a water blocking material to prevent the spread of water within the lumen 24. In such embodiments, the yarn 35 may be impregnated with a water-blocking resin or coated with a water-blocking powder, such as superabsorbent polymer powder. In one or more such embodiments, the yarn 35 functions as an access feature, such as a ripcord. In particular, the yarn 35 can be grasped and pulled to tear through the thin membrane 22 to provide access to the optical fibers 20 within the lumen 24. Because of the thinness of the membrane 22, the yarn 35 does not need to have substantial strength. In one or more embodiments, the yarn 35 has an clastic modulus of about 30 GPa or less, in particular about 10 GPa or less, and most particular about 1 GPa or less. In embodiments, the yarn 35 has an elastic modulus of at least 200 MPa, in particular at least 500 MPa. In embodiments, the yarn 35 is made of polyester strands.

In accordance with other aspects of the present disclosure, other waterblocking technologies may be used in the cable 10. For example, the lumens 24 may be filled with a gel or lubricant for waterblocking. Similarly, a gel or lubricant could be used to coat core components and/or fill the interstitial spaces in the cable core 18. In other aspects of the disclosure, a water blocking tape or yarn may be provided to surround the cable core 18 or provided within the core.

In one or more embodiments, each of the lumens 24 includes a machine readable code 33, such as a barcode or other sequence of markings (including, e.g., printed stripes or dots), as shown in FIG. 6D. The machine readable code 33 can be scanned by an optical device 34, such as a handheld device (in particular a mobile phone), of a user to retrieve information regarding the lumens 24. The machine readable code 33 can be used in addition to the color-coding and ring marking of the lumens 24 or in place of the color-coding and ring marking of the lumens 24.

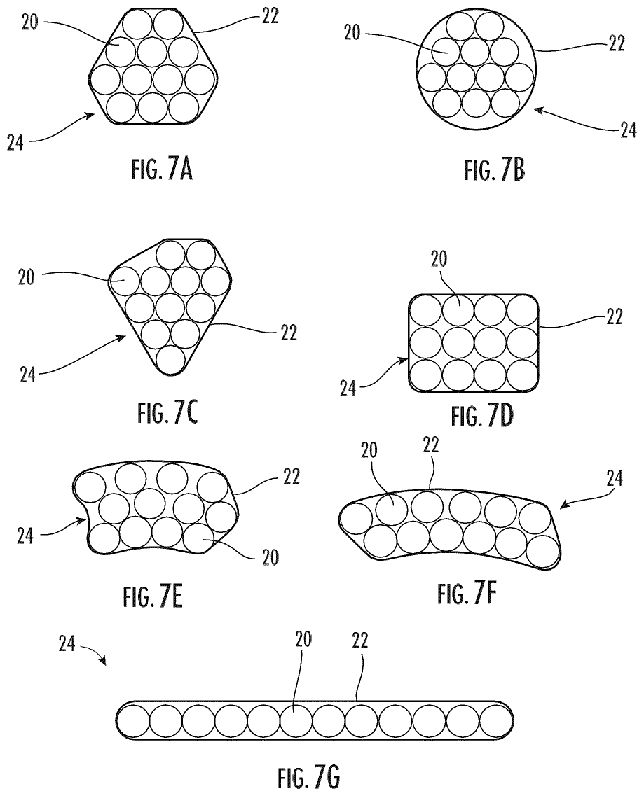

Advantageously, because of the thinness of the membrane 22, the membrane 22 is essentially amorphous and may allow the lumen 24 to be reconfigurable in shape. An example of a diamond-shaped embodiment is shown in FIG. 4A, but from FIGS. 5 and 6B, it can be seen that the lumens 24 have many different shapes to pack them within the cable core 30. FIGS. 7A-7G depict other example shapes for the lumens 24, which are based on a structure including a membrane 22 surrounding twelve optical fibers 20.

FIG. 7A provides an example of a rounded polygon lumen 24. As can be seen in FIG. 7A, the membrane 22 bounds a stack of optical fibers 20 having rows of three, four, three, and two (bottom to top) optical fibers 20 defining a narrow-topped hexagonal shape. The optical fibers 20 of each successive row are nested in the interstices between the optical fibers 20 in the preceding row. FIG. 7B depicts a circle shape of the lumen 24 in which the optical fibers 20 are arranged in the same pattern as in FIG. 7A. However, in the embodiment of FIG. 7B, the membrane 22 does not tightly bound the optical fibers 20, allowing the lumen to adopt the circle shape in a relaxed state.

FIG. 7C provides an example of a sector or irregular pentagon shaped lumen 24. Bottom to top, the sector shape includes rows of one, two, three, four, and two optical fibers 20. The optical fibers 20 of each successive row are nested in the interstices between the optical fibers 20 in the row preceding it, and the membrane 22 tightly bounds the optical fibers 20.

FIG. 7D depicts a rectangular shaped lumen 24. The rectangle includes three rows of four optical fibers 20. In this embodiment, the optical fibers 20 are stacked and not provided in the interstices between the optical fibers 20 in the preceding row. FIG. 7E depicts a nested rectangle lumen 24 that includes three rows of four optical fibers 20. In this embodiment and in contrast to the embodiment of FIG. 7D, the optical fibers 20 of the middle row are shifted into the interstices of the bottom and top rows.

FIG. 7F depicts a curved parallelogram lumen 24. The curved parallelogram includes two rows of six optical fibers 20 in which the top row is shifted into the interstices of the bottom row. FIG. 7G depicts a single row rectangle lumen 24. As can be seen in FIG. 7G, all twelve optical fibers 20 are provided in a single row, similar to an optical fiber ribbon.

Table 1 provides a summary of the geometric parameters of the shapes described in FIGS. 7A-7G. As can be seen from Table 1, the membranes 22 define areas ranging between 0.44 mm² for the soft polygon to 0.52 mm² for the circle. Further, the membranes 22 define an exterior perimeter ranging from 2.4 mm for the soft polygon to 5.0 mm for the single row rectangle. The free space ranges from 13.6% for the soft polygon to 27.0% for the circle. It is noted that the shapes depicted in FIGS. 7A-7G and described in Table 1 are merely exemplary, and other shapes are possible.

TABLE 1
Geometric Parameters of Various 12-Fiber Lumen Constructions

| | Total | Exterior | Inside | Interior | Free |
|---|---|---|---|---|---|
| | Area | Perimeter | Area | Perimeter | Space |
| Geometry | (mm²) | (mm) | (mm²) | (mm) | (%) |
| Soft Polygon | 0.44 | 2.4 | 0.42 | 2.4 | 13.6 |
| Circle | 0.52 | 2.6 | 0.50 | 2.5 | 27.0 |
| Sector | 0.46 | 2.6 | 0.43 | 2.5 | 16.4 |
| Soft Hexagon | 0.45 | 2.6 | 0.42 | 2.6 | 14.0 |
| 3 × 4 Stacked | 0.48 | 2.6 | 0.45 | 2.6 | 20.1 |
| Rectangle | | | | | |
| 3 × 4 Nested | 0.48 | 2.7 | 0.46 | 2.7 | 20.6 |
| Rectangle | | | | | |
| 2 × 6 Curved | 0.47 | 3.1 | 0.44 | 3.1 | 17.9 |
| Parallelogram | | | | | |
| 1 × 12 Rectangle | 0.50 | 5.0 | 0.45 | 4.9 | 20.1 |

Table 2 provides a summary of the geometric parameters for a cable including a plurality of lumens as described in Table 1 and depicted in FIGS. 7A-7G. In particular, the geometric parameters of Table 2 consider an optical fiber cable 10 having twenty-four lumens 24 with twelve optical fibers 20 contained within each of the membrane 22 shapes. In Table 2, the subunit area is the total area of the twenty-four lumens 22 in the cable core 30. The subunit area varies from about 10.6 mm² for the soft polygon to 12.0 mm² for the 1×12 rectangle. The parameter of “Inner Diameter-Lumens Only” is the inner diameter of the cable jacket 12 defined by the inner surface 14 that is needed to accommodate all twenty-four lumens 24. The inner diameter varies from 3.7 mm for the soft polygon, sector, and soft hexagon lumens 24 to 4.0 mm for the circle lumen 24. In embodiments, the cable core 30 of the plurality of lumens 24 is wrapped in a tape, such as a water blocking tape or a binder film 32, and the inner diameter of the cable jacket 12 is increased to accommodate the tape. In such embodiments, the inner diameter varies from 4.3 mm for the soft polygon, sector, and soft hexagon lumens 24 to 4.6 mm for the circle lumens 24. The outer diameter of the optical fiber cable 10 is the outer diameter as measured from the outer surface 16 of the cable jacket 12. Specifically, the outer diameter considered is for a cable core 30 having a tape wrapped around it. As shown in Table 2, the outer diameter varies from 5.1 mm for the soft polygon and soft hexagon lumens 24 to 5.4 mm for the circle and 1×12 rectangle lumens 24. The final parameter listed in Table 2 is the jacket wall thickness (WT) as a percentage of the outer diameter provided in the previous column. In particular, the wall thickness is one half of the difference between the outer diameter and the inner diameter over tape. In embodiments, the wall thickness as a percentage of outer diameter is at least 7.5%, in particular at least 8%, or more, which helps prevent kinking of the jacket during bending.

TABLE 2
Geometric Properties of Optical Fiber Cable
having 288 Fibers in Lumens of 12 Fibers

| | | Inner | Inner | | |
|---|---|---|---|---|---|
| | | Diameter - | Diameter | | WT % of |
| | Subunit | Lumens | Over | Outer | Outer |
| | area | Only | Tape | Diameter | Diameter |
| Subunit type | (mm²) | (mm) | (mm) | (mm) | (%) |
| Soft Polygon | 10.6 | 3.7 | 4.3 | 5.1 | 8.2 |
| Circle | 12.5 | 4.0 | 4.6 | 5.4 | 7.7 |
| Sector | 11.0 | 3.7 | 4.3 | 5.2 | 8.1 |
| Soft Hexagon | 10.7 | 3.7 | 4.3 | 5.1 | 8.2 |
| 3 × 4 Stacked | 11.5 | 3.8 | 4.4 | 5.3 | 8.0 |
| Rectangle | | | | | |
| 3 × 4 Nested | 11.6 | 3.8 | 4.4 | 5.3 | 8.0 |
| Rectangle | | | | | |
| 2 × 6 Curved | 11.3 | 3.8 | 4.4 | 5.2 | 8.0 |
| Parallelogram | | | | | |
| 1 × 12 | 12.0 | 3.9 | 4.5 | 5.4 | 7.8 |
| Rectangle | | | | | |

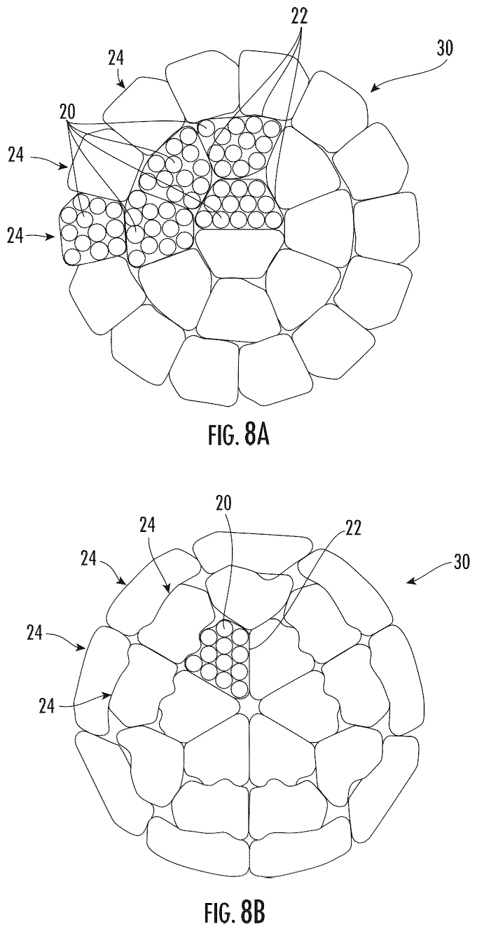

FIGS. 8A and 8B depict examples of cable cores 30 including a plurality of lumens 24 of varying shapes to define an overall circle cable core 30 having 288 optical fibers 20 divided into twenty-four lumens 24. In practice, according to one or more embodiments, all of the lumens 24 may be processed in the form of the 3×4 stacked rectangle (FIG. 7D) or a circle, and in practice, the membrane 28 of the lumen 24 may not be as tightly in contact with the optical fibers 20, providing additional space for the lumens 24 to reconfigure into different shapes. Indeed, when configured in cable cores shown in FIGS. 8A and 8B, the group of membranes 22, which may be stranded or unstranded, may be reshaped according to available position in the cable core 18 and referred to as a lumen bundle 30. In one or more embodiments, lumens 24 in the center of the lumen bundle 30 may have a shape similar to the soft polygon, circle, or sector shape. Being in the center of the lumen bundle 30, these optical fibers 20 are very close to the neutral axis of the optical fiber cable 10, and therefore, their differential strain is very low as the optical fiber cable 10 bends. These center optical fibers 20 will be able to move and adjust length to distribute tensile loading more efficiently. In particular, these center optical fibers 20 will take on more load than the outer optical fibers 20 which have more SZ helical length that will tend to unwind first as tension is applied to the cable.

Because the center subunit(s) 24 take on more of the load, in one or more embodiments, the optical fibers 20 of the center lumens 24 may be made with a higher proof stress fiber, such as 200 kpsi proof stress fiber, and in one or more such embodiments, the other lumens could include optical fibers 20 having a proof stress of 100 kpsi. In one or more other embodiments, the proof stress of the optical fibers 20 may be selected so that optical fibers 20 in lumens 24 at the center have a proof stress of 200 kpsi, optical fibers 20 in lumens 24 in an outer row have a proof stress of 100 kpsi, and optical fibers 20 in lumens 24 between the center and outer row have a proof stress of 150 kpsi. These kpsi proof stress ratings are merely exemplary, and in other embodiments, the exact values needed for the strain and cable load specifications desired can be calculated.

For lumens 24 in the outside layer, the shape shown in FIG. 8A may be an expanded 3×4 rectangle, and the shape shown in FIG. 8B may be a 2×6 curved parallelogram. A similar composite structure is made in the middle layer of lumens 24, which have been reconfigured to the 3×4 nested rectangle. The summation of strength of these outside lumens 24, e.g., in the 2×6 curved parallelogram configuration, in addition to the lesser strength of the middle layer of lumens, e.g., in the 3×4 nested rectangle configuration creates a lumen bundle 30 that may provide tensile strength when a cable tight jacket is applied.

In one or more embodiments, the lumens 24 may comprise a stretchable membrane 22. In such embodiments, the membrane 22 may tightly conform to the optical fibers 20 so that reconfiguring the lumen 24 into different shapes requires stretching of the membrane 22. The stretching of the membrane 22 creates a normal force on the optical fibers 20, compacting them together. As mentioned above, the low free space within the lumen 24 in these embodiments creates a composite strength member of the membrane 22 and optical fibers 20. The stretching of the membrane 22 to compact the optical fibers together enhances the composite strength member effect.

Because the membranes 22 of the lumens 24 are reconfigurable and conformable into a variety of shapes, the conventional stranding layer increments can be disregarded in certain circumstances. In particular, a conventional cable generally includes one or three subunits at the center or a central strength member. For a cable with one subunit or a central strength member at the center that is substantially the same size as the subunits, the next layer of subunits will be six subunits followed by another layer of twelve subunits. Each successive layer will add another six subunits. Similarly, for a conventional cable having three subunits at the center, the next layer will have nine subunits, then fifteen subunits, and an additional six subunits for each successive layer. By using conformable membranes 22 having reconfigurable shapes around the optical fibers 20 in the lumens 24, this layer number of lumens 24 can be modified.

Indeed, FIG. 8A depicts two lumens 24 having membranes 22 conformed to mirrored rounded trapezoids that are surrounded by eight lumens 24 having membranes 22 approximating a circular segment. These lumens are surrounded by fourteen lumens 24 having membranes 22 approximating a polygon. Thus, in addition to the use of the conventional 1, 6, 12 or 3, 9, 15 sequence of lumens, the optical fiber cable 10 of FIG. 8A can have a sequence of 2, 8, 14 lumens 24. In FIG. 8B, six lumens 24 having membranes 22 conforming to a circular sector form a first layer that is surrounded by nine lumens 24 having membranes 22 approximating rectangles defined by a 3×4 matrix of optical fibers 20 within each membrane 22. The third layer is also formed by nine lumens 24 having membranes 22 conformed substantially into a 2×6 parallelogram of optical fibers 20. Thus, the sequence of lumens 24 shown in FIG. 8B is 6, 9, 9.

In one or more embodiments, the lumens 24 of each layer are stranded (e.g., S, Z or SZ stranded), along the length of the optical fiber cable 10. In one or more such embodiments, the lumens 24 are SZ stranded along the length of the optical fiber cable 10. In addition, SZ stranding of the lumens 24 enables the cable to be bent and coiled for slack storage without having high fiber strain and fiber breaks. In one or more such embodiments that include 2×6 curved parallelogram lumens 24, the column strength of the 2×6 curved parallelogram lumens 24 is able to push itself against the compressive strain on the inside of the bend.

As mentioned above, the optical fibers 20 may be a primary strength element of the optical fiber cable 10. In that regard, the optical fiber cable 10, in particular the cable core 18, does not include any conventional strength elements, such as glass-reinforced plastic rods, steel wire, or aramid or glass tensile yarns, amongst other conventional strength elements. In accordance with other aspects of the present disclosure, strength elements may be used in the optical fiber cable 10, in which case the optical fibers 20 may be one component that contributes to the overall strength profile of the optical fiber cable 10.

In general, the various designs of the optical fiber cable 10 described herein are able to eliminate strength elements because the optical fibers 20 within the cable core 30 are coupled together to act as a composite strength element by reducing the amount of free space within the optical fiber cable 10 and within lumens 24 in the optical fiber cable 10.

In one or more embodiments, the optical fiber cable 10 has a cumulative fiber filling coefficient of at least 40%, at least 50%, at least 60%, at least 65%, or at least 70%. In one or more embodiments, the optical fiber cable 10 has a cumulative fiber filling coefficient of up to 80%. As used herein, the term “cumulative fiber filling coefficient” of an optical-fiber cable 10 refers to the ratio of the sum of the cross-sectional areas of all of the optical fibers 20 within the optical-fiber cable 10 versus the inner cross-sectional area of the optical-fiber cable 10 (i.e., defined by the inner surface 14 of the cable jacket 12 or inner surface of binder film 32, if included). The cross-sectional area of each optical fiber 20 is determined based on an outer surface of the optical fiber 20. In one or more embodiments, the optical fiber 20 has an outer color coating layer as described above and discussed more fully below, and the cross-sectional area of the optical fiber 20 is measured from the outer surface as defined by this outer color coating layer. In one or more other embodiments, the optical fiber 20 is a “bare fiber” and does not include an outer color coating layer in which case the cross-sectional area of the optical fiber 20 is measured from the outer surface of the bare fiber.

In one or more embodiments, the optical fiber cable 10 comprises a free space of at most 60%, at most 50%, at most 42.5%, at most 30%, or at most 25%. In one or more embodiments, the free space of the optical fiber cable 10 is at least 20%. As used herein, the free space is the inverse of cumulative fiber filling coefficient (i.e., 100%-cumulative fiber filling coefficient).

In one or more embodiments, the optical fiber cable 10 includes from 48 to 864 optical fibers 20, in particular from 96 to 288 optical fibers 20. In one or more embodiments, the optical fiber cable 10 has a fiber density of at least 7.5 fibers/mm². The fiber density is measured based on the number of optical fibers 20 per cross-sectional area of the optical fiber cable 10 as measured from the outer surface 16. In one or more embodiments, the fiber density is at least 8 fibers/mm², at least 8.5 fibers/mm², at least 9 fibers/mm², at least 9.5 fibers/mm², at least 10 fibers/mm², at least 10.5 fibers/mm², at least 11 fibers/mm², at least 11.5 fibers/mm², or at least 12 fibers/mm². In one or more embodiments, the fiber density may be up to 17 fibers/mm². Further, in one or more embodiments, the outer diameter of the optical fiber cable 10 as measured at the outer surface 16 is 11 mm or less, 9 mm or less, 8.5 mm or less, 8 mm or less, 7.5 mm or less, 7 mm or less, 6.75 mm or less, 6.5 mm or less, 6.25 mm or less, 6 mm or less, 5.75 mm or less, 5.5 mm or less, 5.25 mm or less, or 5 mm or less. Further, in one or more embodiments, the outer diameter of the optical fiber cable 10 as measured from the outer surface 16 is at least 2 mm.

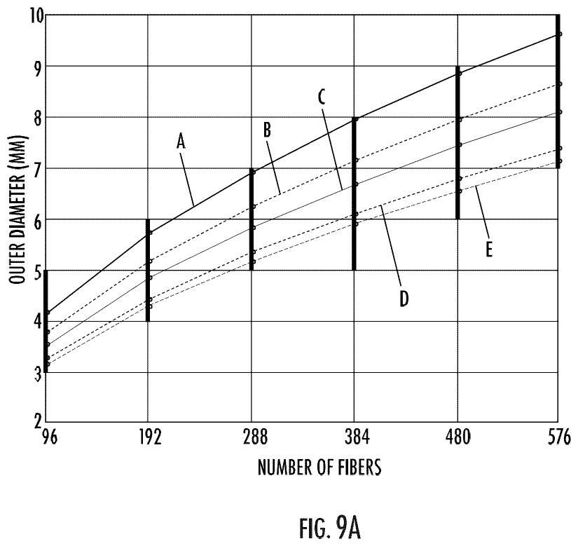

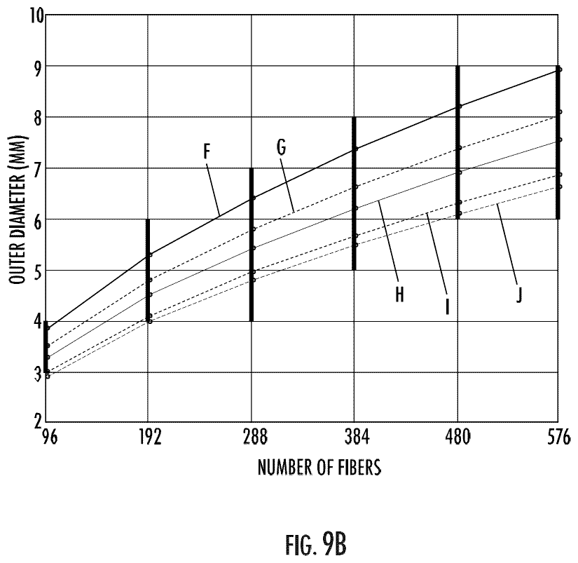

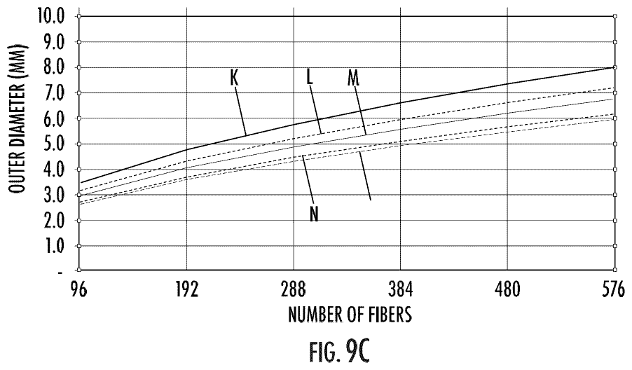

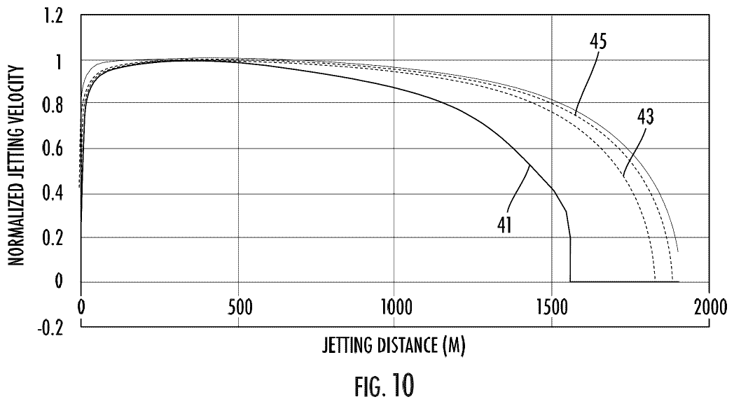

The fiber density and diameter of the optical fiber cable 10 will vary depending primarily on the number of optical fibers 20 in the optical fiber cable 10, size of the optical fibers 20 in the optical fiber cable 10, and the free space in the lumens 24. FIGS. 9A-9C provide graphs of the outer diameter of the optical fiber cable 10 as a function of the number of optical fibers 20 in the optical fiber cable 10. The graph of FIG. 9A considers optical fibers 20 having an outer diameter of 196 microns; the graph of FIG. 9B considers optical fibers 20 having an outer diameter of 180 microns; and the graph of FIG. 9C considers optical fibers 20 having an outer diameter of 160 microns. In the graphs of FIGS. 9A-9C, the optical fiber cable 10 has a binder film 32 having a thickness of 150 microns, and the cable jacket 12 thickness was set at 10% of the outer diameter of the cable jacket 12.

Curves A-E of FIG. 9A represent the free space of the optical fiber cable 10 as defined above in which the optical fibers have an outer diameter of 196 microns, and in which curve A has a free space of 60%, curve B has a free space of 50%, curve C has a free space of 42.5%, curve D has a free space of 30%, and curve E has a free space of 25%. In FIG. 9A, for example, curve B demonstrates that an optical fiber cable 10 having 576 optical fibers 20 and 50% free space will have an outer diameter of about 8.7 mm. If the free space is reduced to 25% as shown on curve E, the outer diameter of the cable 10 decreases to about 7.2 mm. On the other hand, if the free space increases to 60%, the outer diameter of the cable 10 increases to 9.7 mm. For completeness, the outer diameter of the optical fiber cable having 576 optical fibers 20 and 42.5% free space (curve C) and 30% free space (curve D) is 8.1 mm and 7.4 mm, respectively. For optical fiber cables 10 having a relatively lower number of optical fibers 20 (e.g., 864 or fewer fibers), and wherein the optical fibers have a 196 micron diameter, the outer diameter of the optical fiber cable 10 is summarized in Table 3, below.

TABLE 3
Outer Diameter of Cable (mm) Based on Number of Optical
Fibers (196 micron diameter) and Free Space

| | Number of Optical Fibers | | | | | | | |
|---|---|---|---|---|---|---|---|---|
| | | 48 | 96 | 192 | 288 | 432 | 576 | 864 |
| Free | 60 | 3.1 | 4.2 | 5.7 | 6.9 | 8.4 | 9.7 | 11.8 |
| Space | 50 | 2.8 | 3.8 | 5.2 | 6.3 | 7.6 | 8.7 | 11 |
| (%) | 42.5 | 2.6 | 3.5 | 4.9 | 5.9 | 7.1 | 8.1 | 9.9 |
| | 30 | 2.4 | 3.2 | 4.4 | 5.3 | 6.5 | 7.4 | 9.0 |
| | 25 | 2.3 | 3.1 | 4.3 | 5.2 | 6.3 | 7.2 | 8.7 |

Curves F-J of FIG. 9B represent the free space of the optical fiber cable 10 as defined above in which the optical fibers 20 have an outer diameter of 180 microns, and in which curve F has a free space of 60%, curve G has a free space of 50%, curve H has a free space of 42.5%, curve I has a free space of 30%, and curve J has a free space of 25%. In FIG. 9B, curve G demonstrates that an optical fiber cable 10 having 576 optical fibers 20 and 50% free space will have an outer diameter of about 8.0 mm. If the free space is reduced to 25% as shown on curve J, the outer diameter of the cable 10 decreases to about 6.6 mm, whereas if the free space increases to 60%, the outer diameter of the cable 10 increases to 8.9 mm. For completeness, the outer diameter of the optical fiber cable having 576 optical fibers 20 and 42.5% free space (curve H) and 30% free space (curve I) is 7.5 mm and 6.8 mm, respectively. For optical fiber cables 10 having a lower number of optical fibers 20, and wherein the optical fibers have a 196 micron diameter, the outer diameter of the optical fiber cable 10 is summarized in Table 4, below.

TABLE 4
Outer Diameter of Cable (mm) Based on Number of Optical
Fibers (180 micron diameter) and Free Space

| | Number of Optical Fibers | | | | | | | |
|---|---|---|---|---|---|---|---|---|
| | | 48 | 96 | 192 | 288 | 432 | 576 | 864 |
| Free | 60 | 2.8 | 3.9 | 5.3 | 6.4 | 7.8 | 8.9 | 10.8 |
| Space | 50 | 2.6 | 3.5 | 4.8 | 5.8 | 7.0 | 8.0 | 9.7 |
| (%) | 42.5 | 2.4 | 3.3 | 4.5 | 5.4 | 6.5 | 7.5 | 9.1 |
| | 30 | 2.2 | 3.0 | 4.1 | 4.9 | 6.0 | 6.8 | 8.3 |
| | 25 | 2.2 | 2.9 | 4.0 | 4.8 | 5.8 | 6.6 | 8.0 |

Curves K-O of FIG. 9C represent the free space of the optical fiber cable 10 as defined above in which the optical fibers 20 have an outer diameter of 160 microns, and in which curve K has a free space of 60%, curve L has a free space of 50%, curve M has a free space of 42.5%, curve N has a free space of 30%, and curve O has a free space of 25%. In FIG. 9C, curve L demonstrates that an optical fiber cable 10 having 576 optical fibers 20 and 50% free space will have an outer diameter of about 7.2 mm. If the free space is reduced to 25% as shown on curve O, the outer diameter of the cable 10 decreases to about 5.9 mm, whereas if the free space increases to 60%, the outer diameter of the cable 10 increases to 8.0 mm. For completeness, the outer diameter of the optical fiber cable having 576 optical fibers 20 and 42.5% free space (curve M) and 30% free space (curve N) is 6.7 mm and 6.1 mm, respectively. For optical fiber cables 10 having a lower number of optical fibers 20, and wherein the optical fibers have a 160 micron diameter, the outer diameter of the optical fiber cable 10 is summarized in Table 5, below.

TABLE 5
Outer Diameter of Cable (mm) Based on Number of Optical
Fibers (160 micron diameter) and Free Space

| | Number of Optical Fibers | | | | | | | |
|---|---|---|---|---|---|---|---|---|
| | | 48 | 96 | 192 | 288 | 432 | 576 | 864 |
| Free | 60 | 2.6 | 3.5 | 4.8 | 5.7 | 7.0 | 8.0 | 9.7 |
| Space | 50 | 2.3 | 3.2 | 4.3 | 5.2 | 6.3 | 7.2 | 8.7 |
| (%) | 42.5 | 2.2 | 3.0 | 4.0 | 4.9 | 5.9 | 6.7 | 8.1 |
| | 30 | 2.0 | 2.7 | 3.7 | 4.4 | 5.3 | 6.1 | 7.4 |
| | 25 | 2.0 | 2.6 | 3.6 | 4.3 | 5.2 | 5.9 | 7.2 |

The fiber density can then be calculated for each cable 10. The high and low for fiber densities for the optical fiber cables 10 of each size and for each fiber diameter are provided in Table 6, below.

TABLE 6
Fiber Densities for Optical Fibers having 48-864 Optical Fibers

| | | |
|---|---|---|
| | Fiber | Fiber Density |
| Number of | Diameter | (fibers/mm²) |

| Fibers | (microns) | High | Low |
|---|---|---|---|
| 864 | 196 | 14.6 | 8.0 |
| | 180 | 17.1 | 9.4 |
| | 160 | 21.4 | 11.8 |
| 576 | 196 | 14.3 | 7.8 |
| | 180 | 16.8 | 9.2 |
| | 160 | 20.9 | 11.6 |
| 432 | 196 | 14.1 | 7.8 |
| | 180 | 16.5 | 9.1 |
| | 160 | 20.5 | 11.4 |
| 288 | 196 | 13.7 | 7.6 |
| | 180 | 16.0 | 8.9 |
| | 160 | 19.9 | 11.1 |
| 192 | 196 | 13.3 | 7.4 |
| | 180 | 15.5 | 8.7 |
| | 160 | 19.1 | 10.8 |
| 96 | 196 | 12.3 | 7.0 |
| | 180 | 14.3 | 8.2 |
| | 160 | 17.6 | 10.1 |
| 48 | 196 | 11.2 | 6.5 |
| | 180 | 12.9 | 7.6 |
| | 160 | 15.7 | 9.3 |

In one or more embodiments, the optical fibers 20 (whether organized into groups 21, 23 or lumens 24, 28) take up at least 75%, at least 80%, at least 85%, at least 90%, or at least 95% of the tensile load on the optical fiber cable 10. The amount of tensile load taken up by the optical fibers 20 can be represented by the ratio of tensile rigidity of the optical fibers 20 to the tensile rigidity of the optical fiber cables 10. The tensile rigidity of the optical fibers 20 is the elastic modulus (E) of the optical fibers 20 multiplied by their cumulative cross-sectional area (A) within the optical fiber cable 10. The cumulative cross-sectional area of the optical fibers 20 is the sum of the cross-sectional area of each optical fiber 20 based on the outer diameter of the optical fibers 20. The tensile rigidity of the optical fiber cable 10 is the sum of the products of the elastic moduli (E) of each component of the optical fiber cable 10 multiplied by the component's cross-sectional area (A) or cumulative cross-sectional area (A).

Tables 7-13 provide example calculations of the tensile load taken up by the optical fibers 20 for optical fiber cables 10 having various amounts of optical fibers 20 within the optical fiber cable 10. The determination of the tensile load taken up by the optical fibers 20 was based on optical fibers 10 having an outer diameter of 196 microns with coating layers having a total thickness of about 35 microns around the core and cladding, a binder film 32 having a thickness of 150 microns, twelve optical fibers 20 per lumen 24, lumens 24 having membranes 22 with a thickness of 20 microns, and a cable jacket 10 having a thickness of 10% of the outer diameter based on FIG. 9A at a free space of 50%.

TABLE 7
Tensile Rigidity in Optical Fiber Cable with 576 Optical Fibers.

| | | Outer | Inner | | Tensile | % of |
|---|---|---|---|---|---|---|
| | | Diameter | Diameter | Modulus | Rigidity | Tensile |
| | Number | (mm) | (mm) | (MPa) | (N) | Load |
| Binder Film 32 | 1 | 6.96 | 6.66 | 400 | 1280 | 0.25 |
| Cable Jacket 12 | 1 | 8.7 | 6.96 | 600 | 12840 | 2.50 |
| Lumens 24 | 48 | 0.9 | 0.86 | 1000 | 2650 | 0.52 |
| Coating Layers | 576 | 0.196 | 0.125 | 200 | 2060 | 0.40 |
| of Optical Fibers 20 | | | | | | |
| Core/Cladding | 576 | 0.125 | 0 | 70000 | 494800 | 96.33 |
| of Optical Fibers 20 | | | | | | |
| | | | | Sum | 513630 | |

TABLE 8
Tensile Rigidity in Optical Fiber Cable with 480 Optical Fibers.

| | | Outer | Inner | | Tensile | % of |
|---|---|---|---|---|---|---|
| | | Diameter | Diameter | Modulus | Rigidity | Tensile |
| | Number | (mm) | (mm) | (MPa) | (N) | Load |
| Binder Film 32 | 1 | 6.37 | 6.07 | 400 | 1173 | 0.27 |
| Cable Jacket 12 | 1 | 8.00 | 6.37 | 600 | 10765 | 2.51 |
| Lumens 24 | 40 | 0.9 | 0.86 | 1000 | 2212 | 0.52 |
| Coating Layers | 480 | 0.196 | 0.125 | 200 | 1718 | 0.40 |
| of Optical Fibers 20 | | | | | | |
| Core/Cladding | 480 | 0.125 | 0 | 70000 | 412334 | 96.29 |
| of Optical Fibers 20 | | | | | | |
| | | | | Sum | 428203 | |

TABLE 9
Tensile Rigidity in Optical Fiber Cable with 384 Optical Fibers.

| | | Outer | Inner | | Tensile | % of |
|---|---|---|---|---|---|---|
| | | Diameter | Diameter | Modulus | Rigidity | Tensile |
| | Number | (mm) | (mm) | (MPa) | (N) | Load |
| Binder Film 32 | 1 | 5.73 | 5.43 | 400 | 1052 | 0.31 |
| Cable Jacket 12 | 1 | 7.16 | 5.73 | 600 | 8708 | 2.54 |
| Lumens 24 | 32 | 0.9 | 0.86 | 1000 | 1769 | 0.52 |
| Coating Layers | 384 | 0.196 | 0.125 | 200 | 1375 | 0.40 |
| of Optical Fibers 20 | | | | | | |
| Core/Cladding | 384 | 0.125 | 0 | 70000 | 329867 | 96.24 |
| of Optical Fibers 20 | | | | | | |
| | | | | Sum | 342772 | |

TABLE 10
Tensile Rigidity in Optical Fiber Cable with 288 Optical Fibers.

| | | Outer | Inner | | Tensile | % of |
|---|---|---|---|---|---|---|
| | | Diameter | Diameter | Modulus | Rigidity | Tensile |
| | Number | (mm) | (mm) | (MPa) | (N) | Load |
| Binder Film 32 | 1 | 5 | 4.7 | 400 | 915 | 0.36 |
| Cable Jacket 12 | 1 | 6.25 | 5 | 600 | 6637 | 2.58 |
| Lumens 24 | 24 | 0.9 | 0.86 | 1000 | 1327 | 0.52 |
| Coating Layers | 288 | 0.196 | 0.125 | 200 | 1031 | 0.40 |
| of Optical Fibers 20 | | | | | | |
| Core/Cladding | 288 | 0.125 | 0 | 70000 | 247400 | 96.15 |
| of Optical Fibers 20 | | | | | | |
| | | | | Sum | 257310 | |

TABLE 11
Tensile Rigidity in Optical Fiber Cable with 192 Optical Fibers.

| | | Outer | Inner | | Tensile | % of |
|---|---|---|---|---|---|---|
| | | Diameter | Diameter | Modulus | Rigidity | Tensile |
| | Number | (mm) | (mm) | (MPa) | (N) | Load |
| Binder Film 32 | 1 | 4.14 | 3.84 | 400 | 752 | 0.44 |
| Cable Jacket 12 | 1 | 5.18 | 4.14 | 600 | 4545 | 2.65 |
| Lumens 24 | 16 | 0.9 | 0.86 | 1000 | 885 | 0.51 |
| Coating Layers | 192 | 0.196 | 0.125 | 200 | 687 | 0.40 |
| of Optical Fibers 20 | | | | | | |
| Core/Cladding | 192 | 0.125 | 0 | 70000 | 164934 | 96.00 |
| of Optical Fibers 20 | | | | | | |
| | | | | Sum | 171803 | |

TABLE 12
Tensile Rigidity in Optical Fiber Cable with 96 Optical Fibers.

| | | Outer | Inner | | Tensile | % of |
|---|---|---|---|---|---|---|
| | | Diameter | Diameter | Modulus | Rigidity | Tensile |
| | Number | (mm) | (mm) | (MPa) | (N) | Load |
| Binder Film 32 | 1 | 3.02 | 2.72 | 400 | 540 | 0.63 |
| Cable Jacket 12 | 1 | 3.77 | 3.02 | 600 | 2411 | 2.80 |
| Lumens 24 | 8 | 0.9 | 0.86 | 1000 | 442 | 0.51 |
| Coating Layers | 96 | 0.196 | 0.125 | 200 | 344 | 0.40 |
| of Optical Fibers 20 | | | | | | |
| Core/Cladding | 96 | 0.125 | 0 | 70000 | 82467 | 95.66 |
| of Optical Fibers 20 | | | | | | |
| | | | | Sum | 86204 | |

TABLE 13
Tensile Rigidity in Optical Fiber Cable with 48 Optical Fibers.

| | | Outer | Inner | | Tensile | % of |
|---|---|---|---|---|---|---|
| | | Diameter | Diameter | Modulus | Rigidity | Tensile |
| | Number | (mm) | (mm) | (MPa) | (N) | Load |
| Binder Film 32 | 1 | 2.22 | 1.92 | 400 | 390 | 0.90 |
| Cable Jacket 12 | 1 | 2.78 | 2.22 | 600 | 1307 | 3.01 |
| Lumens 24 | 4 | 0.9 | 0.86 | 1000 | 221 | 0.51 |
| Coating Layers | 48 | 0.196 | 0.125 | 200 | 172 | 0.40 |
| of Optical Fibers 20 | | | | | | |
| Core/Cladding | 48 | 0.125 | 0 | 70000 | 41233 | 95.18 |
| of Optical Fibers 20 | | | | | | |
| | | | | Sum | 43323 | |

In one or more embodiments, the optical fibers 20 comprise a tensile rigidity of at least 30,000 N, at least 35,000 N, or at least 40,000 N for an optical fiber cable 10 having 48 optical fibers 20 and a tensile rigidity of 50,000 N or less. In one or more embodiments, the optical fibers 20 comprise a tensile rigidity of at least 60,000 N, at least 70,000 N, or at least 80,000 N for an optical fiber cable 10 having 96 optical fibers 20 and a tensile rigidity of 100,000 N or less. In one or more embodiments, the optical fibers 20 comprise a tensile rigidity of at least 120,000 N, at least 140,000 N, or at least 160,000 N for an optical fiber cable 10 having 192 optical fibers 20 and a tensile rigidity of 180,000 N or less. In one or more embodiments, the optical fibers 20 comprise a tensile rigidity of at least 175,000 N, at least 200,000 N, or at least 225,000 N for an optical fiber cable 10 having 288 optical fibers 20 and a tensile rigidity of 300,000 N or less. In one or more embodiments, the optical fibers 20 comprise a tensile rigidity of at least 250,000 N, at least 280,000 N, or at least 310,000 N for an optical fiber cable 10 having 384 optical fibers 20 and a tensile rigidity of 350,000 N or less. In one or more embodiments, the optical fibers 20 comprise a tensile rigidity of at least 300,000 N, at least 350,000 N, or at least 400,000 N for an optical fiber cable 10 having 480 optical fibers 20 and a tensile rigidity of 450,000 N or less. In one or more embodiments, the optical fibers 20 comprise a tensile rigidity of at least 375,000 N, at least 425,000 N, or at least 475,000 N for an optical fiber cable 10 having 576 optical fibers 20 and a tensile rigidity of 550,000 N or less.

In one or more embodiments of cables without strength members, the optical fibers 20 (whether organized into groups 21, 23 or lumens 24, 26) of the optical fiber cable 10 may have the highest elastic modulus of any component in the optical fiber cable 10. In one or more such embodiments, no component in the optical fiber cable 10 besides the optical fibers 20 has a modulus higher than 48 GPa, higher than 40 GPa, higher than 30 GPa, or higher than 25 GPa.

In one or more embodiments, all lumens 24 in the lumen bundle 30 are SZ stranded in unison with a common lay length. The path length for each lumen 24 while in a constant helix can be described by the following equation:

$$HL = \sqrt{( 2 π {r}^{2} ) + {L}^{2}}$$

where HL is the helical path length, L is the sample length, and r is the radial location of the lumen 24 with respect to the center of the lumen bundle 30. A Helix Factor can be defined as HL/L. When such a lumen bundle 30 is subject to a tensile load, the SZ stranding may tend to unwind, such unwinding is resisted by the coupling of the lumen bundle 30 outer layer with the layers of material surrounding the lumen bundle 30. In the conservative case where the unwinding is uncontested, the tensile rigidity of the individual optical fibers 20 within the lumen bundle 30 will begin to contribute to the cumulative tensile rigidity of the optical fiber cable 10 as the helical path length HL is consumed by cable strain. When the cable strain reaches the maximum helical path length HL, all optical fibers 20 in the lumen bundle 30 will be contributing to the tensile rigidity of the optical fiber cable 10. In the ideal case where the SZ lumen bundle 30 acts like a unit of helical core with a helix factor (HL/L) equal to the average helix factor of the SZ lumen bundle 30 and with freely rotating ends, the cumulative tensile rigidity will increase linearly from the onset of strain in the center optical fibers 20 until all optical fibers 20 are fully engaged, i.e., when core strain is equal to the helix factor of the outermost optical fibers 20 in the lumen bundle 30.

As mentioned above, the membrane 22 of the lumen 24 may be able to be reconfigured into a 1×12 shape, which means that the lumen 24 acts essentially like an optical fiber ribbon. In this configuration, the amorphous membrane 22 will hold the optical fibers 20 side-by-side, providing the planarity needed for mass fusion splicing. Advantageously, the lumen 24 provides an advancement over conventional optical fiber ribbons which need more than 60% free space for performance adequate performance. Because the optical fibers 20 in the membranes 22 can act as loose fibers inside the optical fiber cable 10, less free space is required. In particular, the free space is less than 60%, less than 40%, or even as low as 20%. Thus, the lumens 24 can combine the advantages of both loose fibers and ribbons in terms of free space and mass fusion splicing.

Although the optical fibers 20 in the membrane 22 will likely not have the correct sequence (standard color sequence is blue, orange, green, brown, slate, white, red, black, yellow, violet, rose, aqua) for mass fusion splicing immediately upon flattening the lumen 24, the membrane 22 provides a processing aid to arrange the optical fibers 20 in the correct sequence. When the proper sequence is provided, the field technician can place the membrane 22 in a thermal stripper device and heat the membrane 22 so that the membrane 22 melts and sticks or bonds to the optical fibers 20. This makes the 1×12 configuration permanent, and after cooling, the lumen 24 can then be processed in the same way as a ribbon (e.g., stripped, cleaved, and spliced).

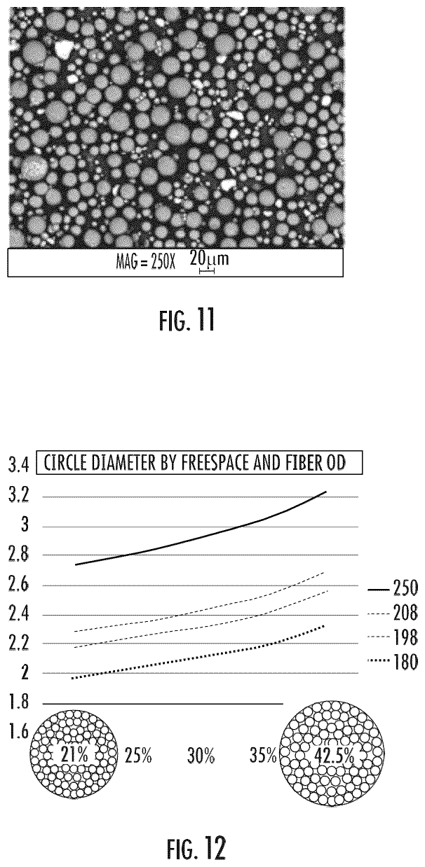

As discussed above, lumens 24 or the multi-lumens 26 may be stranded (such as SZ-stranded) in the lumen bundle 30 in embodiments, including a binder film 32 provided around switchbacks and the full length of the lumen bundle 30. The stranding provides the ability to bend the cable while minimizing tensile and contractive forces within any of the fibers. During cable bending, the optical fibers 20 must be able to shift position, moving longitudinally to relieve those forces so as not to cause attenuation or break the optical fibers 20. In some embodiments, because the membranes 22, 28, and lumen bundle 30 do not provide free space for the optical fibers 20 to increase fiber density by design, the lumens 24 and multi-lumens 26 may need the ability to move relative to each other in certain embodiments. To provide such motion, one or more embodiments of the optical fiber cable 10 include spherical powder (FIG. 11) that act essentially as ball-bearings between lumens 24, 26 to facilitate lower friction and allow individual lumen longitudinal movement during cable bending. In one or more embodiments, the powder is selected to also swell and stop water penetration. In one or more embodiments, the powder has a median particle size of 25 μm, and 90% of the powder particles have a size less than 32 μm.

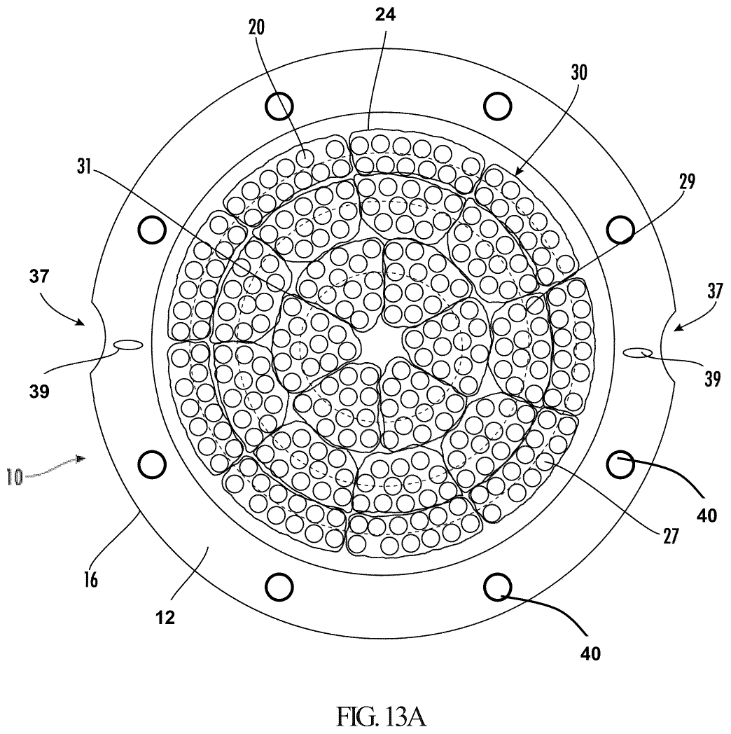

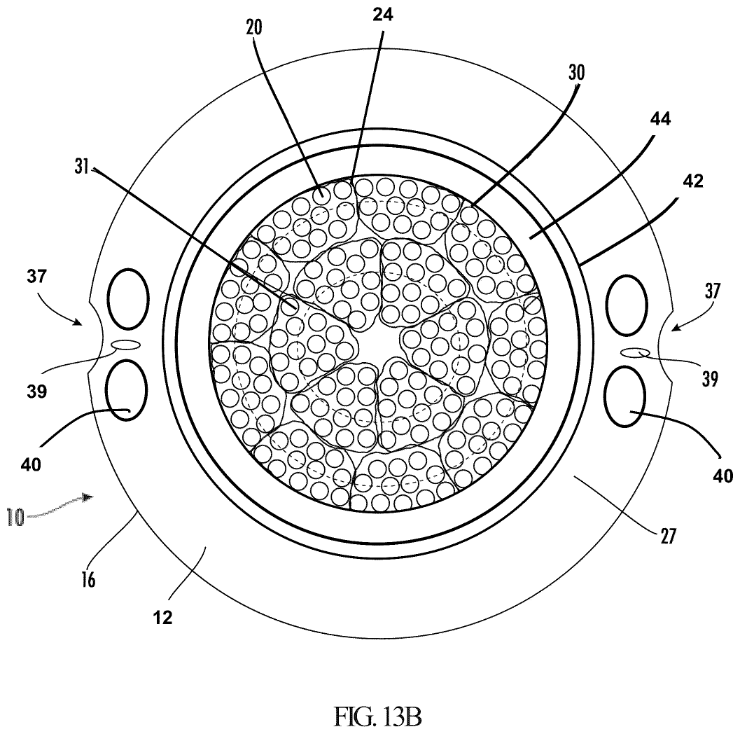

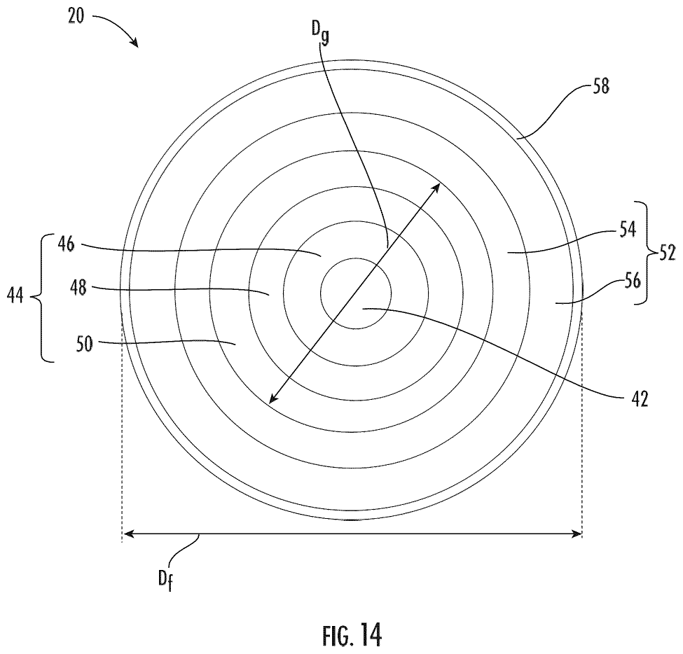

FIG. 12 shows the diameter of a 96-fiber lumen bundle 30 for different combinations of optical fiber diameters and cable core free space. As shown in FIG. 12, the diameter of the cable core 30 increases for a given free space as the diameter of the optical fiber 20 increases. Thus, for example, a cable core 30 comprised of ninety-six optical fibers 20 having a diameter of 180 microns and 21% free space has a diameter of less than 2 mm, whereas a cable core 30 comprised of ninety-six optical fibers 20 having a diameter of 250 microns and 21% free space has a diameter of greater than 2.7 mm. As shown in FIG. 12, for cable cores 30 having the same number of optical fibers 20, the difference in cable core diameter increases as a function of optical fiber diameter as the free space increases.

In accordance with other aspects of the present disclosure, and as shown in FIGS. 13 and 14, conventional strength members 40 may be provided as shown, embedded in jacket 12, such as to assist with compressive loading due to jacket shrinkage and antibuckling, for example. The strength members 40 may be in the form of strength members embedded in the jacket 12 and/or strength members provided between the jacket 12 and the lumens 24. The strength member(s) may be glass-reinforced plastic (GRP) rods, metal wires, tensile strands, or any other suitable strength member used for optical cables. As shown in FIG. 14, optical fiber cables 10 may further include an armor layer 42, which may be a two-piece armor applied around the lumen bundle 30, for example, and a protective layer 44, which may be a layer of compressive material, such as a foam material, a tape layer, or any other suitable material situated between the fiber bundle 30 and the armor layer 44 to provide additional protection to the fibers 20 in the fiber bundle 30. As also shown in FIG. 14, the jacket 12 may also be formed to have a thickness to accommodate more standard strength elements, such as GRP rods.

Having described the optical fiber cable 10, embodiments of a method for manufacturing an optical fiber cable 10 including a plurality of lumens 24 are provided. In one or more embodiments, each lumen 24 is constructed by extruding a membrane 22 around a plurality of optical fibers 20 and, optionally, a yarn 35. In one or more other embodiments, each lumen 24 is constructed by wrapping a membrane 22 around a plurality of optical fibers 20 and, optionally, a yarn 35. For example, a roll of membrane material can be unspooled and wrapped around the plurality of optical fibers 20. The wrapped membrane material can be joined around the plurality of optical fibers 20 using, e.g., laser welding, ultrasonic welding, or seam welding, among other possibilities.

The lumens 24, prepared according to any of the foregoing methods, are formed into a lumen bundle 30. In embodiments, the lumens 24 extend straight along the longitudinal axis in the cable core 18, and in other embodiments, the lumens 24 are stranded (e.g., S-stranded, Z-stranded, or SZ-stranded) along the longitudinal axis in the cable core 18.

In one or more embodiments, a plurality of lumens 24 are arranged into two or more multi-lumens 26 by extruding a membrane around the lumens 24 or wrapping and sealing a membrane material around the lumens 24.

In one or more embodiments, a binder film 32 is extruded around a plurality of lumens 24, a plurality of multi-lumens 26, or a combination of one or more lumens 24 with one or more multi-lumens 26.

A cable jacket 12 is then extruded around the lumens 24, multi-lumens 26, or binder film 32, as the case may be. During extrusion of the cable jacket 12, the access feature 39 and the tactile locator features 37 may be formed in the cable jacket 12 through the use of specially-configured extrusion die-heads. A vacuum may be pulled during extrusion of the cable jacket 12, which squeezes the cable jacket 12 down around the lumens 24. Additionally or alternatively, the cable jacket 12 can be made thicker, which results in greater shrinkage during cooling, compressing the lumens 24. Advantageously, by compressing the cable jacket 12 around the lumens 24, the individual lumens 24 may be manufactured with a higher than desired free space, and the force of the cable jacket 12 on the lumens 24 in the cable core 30 can reconfigure the lumens 24 into shapes with lower free space within the optical fiber cable 10.

Having described the construction of the optical fiber cable 10, embodiments of optical fibers 20 having a construction specially adapted for high fiber density applications are described below in greater detail. In that regard, the discussion of the optical fibers will make reference to various technical terms, definitions of which are provided in the following paragraphs:

“Refractive index” refers to the refractive index at a wavelength of 1550 nm.

The “refractive index profile” is the relationship between refractive index or relative refractive index and waveguide fiber radius. The radius for each region of the refractive index profile is given by the abbreviations r₁, r₂, r₃, r₄, etc. and lower and upper case are used interchangeably herein (e.g., r₁ is equivalent to R₁).

The “relative refractive index percent” is defined as Δ%=100×(nᵢ²-n_{c}²)/2nᵢ², and as used herein nᵢ is the refractive index of region i of the optical fiber and ne is the refractive index of undoped silica. As used herein, the relative refractive index is represented by A and its values are given in units of “%”, unless otherwise specified. The terms: delta, A, A %, % A, delta %, % delta, and percent delta may be used interchangeably herein. In cases where the refractive index of a region is less than the average refractive index of undoped silica, the relative index percent is negative and is referred to as having a depressed region or depressed index. In cases where the refractive index of a region is greater than the average refractive index of the cladding region, the relative index percent is positive.

An “updopant” is herein considered to be a dopant which has a propensity to raise the refractive index relative to pure undoped SiO₂. Examples of updopants include GeO₂ (germania), Al₂O₃, P₂O₅, TiO₂, Cl, Br.

A “downdopant” is herein considered to be a dopant which has a propensity to lower the refractive index relative to pure undoped SiO₂. Examples of down dopants include fluorine and boron.

“Chromatic dispersion”, herein referred to as “dispersion” unless otherwise noted, of a waveguide fiber is the sum of the material dispersion, the waveguide dispersion, and the inter-modal dispersion. In the case of single mode waveguide fibers, the inter-modal dispersion is zero. Zero dispersion wavelength is a wavelength at which the dispersion has a value of zero. Dispersion slope is the rate of change of dispersion with respect to wavelength.

“Effective area” is defined as:

$${A}_{eff} = \frac{2 {π [ {\int }_{0}^{∞} {( f ( r ) )}^{2} rdr ]}^{2}}{{\int }_{0}^{∞} {( f ( r ) )}^{4} rdr}$$

where f(r) is the transverse component of the electric field associated with light propagated in the waveguide. As used herein, “effective area” or “A_{eff}” refers to optical effective area at a wavelength of 1550 nm unless otherwise noted.

The trench volume V₃ is defined for a depressed index region

$${V}_{3} = \vert 2 {\int }_{{r}_{T r e n c h , i n n e r}}^{{r}_{T r e n ch , outer}} ( {Δ}_{T r e n c h} ( r ) - {Δ}_{c} ) rdr \vert$$

where r_{Trench,inner} is the inner radius of the trench cladding region, r_{Trench,outer} is the outer radius of the trench cladding region, A_{Trench}(r) is the relative refractive index of the trench cladding region, and Ac is the average relative refractive index of the common outer cladding region of the glass fiber. In embodiments in which a trench is directly adjacent to the core, r_{Trench,outer} is r₂=r₁ (outer radius of the core), r_{Trench,outer} is 13, and A_{Trench} is Δ3(r). In embodiments in which a trench is directly adjacent to an inner cladding region, r_{Trench,inner} is 12>r₁, r_{Trench,outer} is r₃, and A_{Trench} is Δ3(r). Trench volume is defined as an absolute value and has a positive value. Trench volume is expressed herein in units of % Δ-micron², % Δ-μm², or %-micron², %-μm², whereby these units can be used interchangeably.

The term “a-profile” refers to a relative refractive index profile, expressed in terms of Δ(r) which is in units of “%”, where r is radius, which follows the equation,

$$Δ ( r ) = Δ ( {r}_{0} ) [ 1 - {[ \frac{\vert r - {r}_{0} \vert}{( r - {r}_{0}} ]}^{α} ]$$

where r₀ is the point at which Δ(r) is maximum, r₁ is the point at which Δ(r) % is zero, and r is in the range rᵢ≤r≤r_{f}, where A is defined above, r₁ is the initial point of the α-profile, r_{f} is the final point of the a-profile, and a is an exponent which is a real number.

The mode field diameter (MFD) is measured using the Peterman II method wherein,

$$MFD = 2 w$$

$${w}^{2} = 2 \frac{{\int }_{0}^{∞} {( f ( r ) )}^{2} rdr}{{\int }_{0}^{∞} {( \frac{df ( r )}{dr} )}^{2} rdr}$$

Mode field diameter depends on the wavelength of the optical signal in the optical fiber. Specific indication of the wavelength will be made when referring to mode field diameter herein. Unless otherwise specified, mode field diameter refers to the LP₀₁ mode at the specified wavelength.

The theoretical fiber cutoff wavelength, or “theoretical fiber cutoff”, or “theoretical cutoff”, for a given mode, is the wavelength above which guided light cannot propagate in that mode. A mathematical definition can be found in Single Mode Fiber Optics, Jeunhomme, pp. 39-44, Marcel Dekker, New York, 1990 wherein the theoretical fiber cutoff is described as the wavelength at which the mode propagation constant becomes equal to the plane wave propagation constant in the outer cladding. This theoretical wavelength is appropriate for an infinitely long, perfectly straight fiber that has no diameter variations.

Fiber cutoff is measured by the standard 2 m (2 meter) fiber cutoff test, FOTP-80 (EIA-TIA-455-80), to yield the “fiber cutoff wavelength”, also known as the “2 m fiber cutoff” or “measured cutoff.” The FOTP-80 standard test is performed to either strip out the higher order modes using a controlled amount of bending, or to normalize the spectral response of the fiber to that of a multimode fiber.

Cabled cutoff wavelength, or “cabled cutoff” as used herein, refers to the 22 m (22 meter) cabled cutoff test described in the EIA-445 Fiber Optic Test Procedures, which are part of the EIA-TIA Fiber Optics Standards, that is, the Electronics Industry Alliance—Telecommunications Industry Association Fiber Optics Standards.

Unless otherwise noted herein, optical properties (such as dispersion, dispersion slope, etc.) are reported for the LP₀₁ mode.

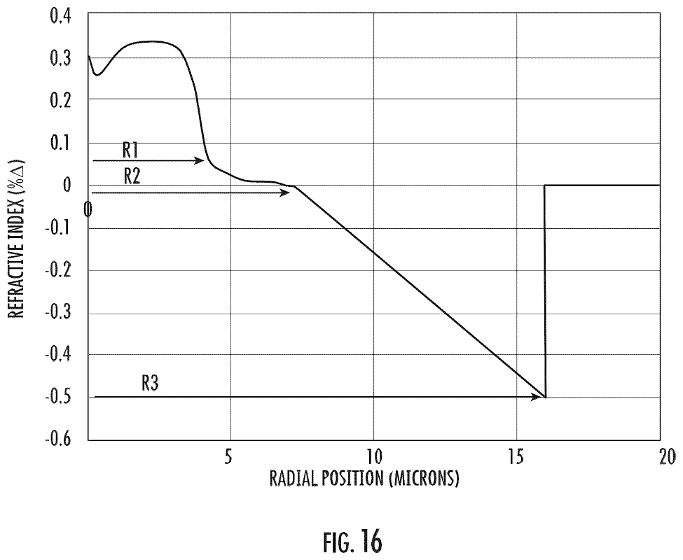

Referring to FIG. 14, the terminal end of optical fibers 20 includes a core 42 surrounded by a cladding region 44. In one or more embodiments, including the embodiment depicted in FIG. 14, the cladding region 44 includes a first cladding layer 46, a second cladding layer 48, and a third cladding layer 50. However, in one or more other embodiments, the cladding region 44 only includes two layers of cladding. In embodiments, the second cladding layer 48 of the three layer cladding region 44 defines a trench region as will be discussed more fully below. In embodiments in which the cladding region 44 only has two layers, the cladding layer adjacent to the core 42 defines the trench region. Further, as will be discussed more fully below, the trench region may have a substantially constant refractive index (referred to as a “rectangular trench”) as shown in FIG. 15, or the trench region may have a continuously varying refractive index (“referred to as a triangular trench”) as shown in FIG. 16.

In one or more embodiments, the cladding region 44 includes a cladding layer (e.g., second cladding layer 48) having a trench volume of greater than about greater than about 25% Δ-μm². In one or more embodiments, the trench volume is greater than about 30% Δ-μm², greater than about 40% Δ-μm², greater than about 50% Δ-μm², or greater than about 60%% Δ-μm². In one or more embodiments, the trench volume is less than about 70% Δ-μm², less than about 65% Δ-μm², or less than about 60% Δ-μm². In one or more embodiments, the trench volume is from about 25% Δ-μm² to about 70% Δ-μm², about 30% Δ-μm² to about 70% Δ-μm², about 40% Δ-μm² to about 70% Δ-μm², about 50% Δ-μm² to about 70% Δ-μm², about 60% Δ-μm² to about 70% Δ-μm², about 30% Δ-μm² to about 60% Δ-μm², about 30% Δ-μm² to about 50% Δ-μm², about 30% Δ-μm² to about 40% Δ-μm², about 40% Δ-μm² to about 60% Δ-μm², or about 50% Δ-μm² to about 60% Δ-μm². For example, the trench volume is about 30% Δ-μm², about 35% Δ-μm², about 40% Δ-μm², about 45% Δ-μm², about 46%%Δ-μm², about 47%Δ-μm², about 48%%Δ-μm², about 49%Δ-μm², about 50%Δ-μm², about 55% Δ-μm², about 60% Δ-μm², about 61% Δ-μm², about 62% Δ-μm², about 68% Δ-μm², about 69% Δ-μm², about 70% Δ-μm², or any trench volume between these values.

In some embodiments, the outer trench radius (corresponding to R₃ in the embodiment of FIG. 14) is between 11 microns and 20 microns. In other embodiments, the outer trench radius is between 12 microns and 18 microns.

In one or more embodiments, the core 42 and cladding region 44 are comprised of a glass material. In one or more embodiments, the core is comprised of germania-doped silica, and the trench (e.g., second cladding layer 48 in the embodiment of FIG. 14) is comprised of a fluorine-doped silica. In one or more embodiments, the shape of the optical fiber 20 may be a circular end shape or circular cross-sectional shape as shown in FIG. 14. In one or more other embodiments, end and cross-sectional shapes and sizes may be employed including elliptical, hexagonal and various polygonal forms.

In one or more embodiments, the core 42 has a first radius R₁ that is from 4 microns to 6 microns. In one or more embodiments, the first cladding layer 46 has a second radius R₂, the second cladding layer 48 has a radius R₃, and the third cladding layer has a radius R₄. In one or more embodiments, the second radius R₂ is from 7 microns and 13 microns. In one or more embodiments, the third radius R₃ is from 11 microns and 20 microns. In one or more embodiments, the fourth radius R₄ is from 60 microns to 65 microns. The cladding region 44 defines a maximum cross-sectional dimension of the glass of the optical fiber 20. In embodiments in which the optical fiber 20 has a circular end or cross-section, the maximum cross-sectional dimension is a glass diameter Dg of the optical fiber 20. In one or more embodiments, the glass diameter Dg is from 120 microns to 130 microns.

For the purpose of this disclosure, the refractive index in each of the core 42, first cladding layer 46, and second cladding layer 48 are defined with respect to the refractive index Δ₄ of the third cladding layer 50, i.e., Δ4=0% Δ. As shown in FIGS. 2 and 3, the core 42 has a maximum core index of Δ_{1,max}. In one or more embodiments, the maximum core refractive index Δ_{1,max} is between 0.3% A and 0.45% A. Further, the first cladding layer 46 has an average index of Δ₂. In one or more embodiments, the refractive index 42 is between −0.05% Δ to 0.05% Δ. The second cladding layer 48 defining the fluorine doped trench has a minimum trench index of 43.min. In one or more embodiments, the minimum trench refractive index Δ_{3,min} is between −0.1% Δ and −0.5% Δ, in particular between-0.15%Δ and −0.4% Δ.

In one or more embodiments, the core 42 is a step index with a core alpha of greater than 10. In other embodiments, the core 42 is a graded index core having a core alpha between 1.5 and 5. The core alpha is defined as an exponent a wherein the refractive index in the core 42 as a function of radial position is described by the refractive index relation Δ% (r)=Δ_{1,max}*[1−(r/R₁)^{α}].

Disposed around the cladding region 44 is a coating 52 that surrounds and encapsulates the glass core 42 and cladding region 44. In embodiments, the coating 52 is configured to provide mechanical protection for the optical fiber 20. In one or more embodiments, the coating 52 includes an inner or primary coating 54 and an outer or secondary coating 56. In one or more embodiments, the primary coating 54 directly contacts the cladding region 44, and the secondary coating 56 directly contacts the primary coating 54. In one or more embodiments, the secondary coating 56 defines the outermost surface of the optical fiber 20. However, in one or more other embodiments, the optical fiber 20 further includes a color layer 58, which may be used to identify the optical fiber 20. In embodiments in which the color layer 58 is included, the color layer 58 may define the outermost surface of the optical fiber 20.

In one or more embodiments, the coating 52 has a thickness in the range of 22-45 microns, or in the range of 22-40 microns, or in the range of 22-35 microns. In one or more embodiments, the coating 52 has a ratio of the thickness of the secondary coating 56 to the thickness of the primary coating 54 in the range of 0.65 to 1.0. According to one or more other embodiments, the ratio of the secondary coating 56 thickness to the primary coating 54 thickness may be in the range of 0.70 to 0.95, more particularly in the range of 0.75 to 0.90, and most particularly in the range of 0.75 to 0.85. In one or more embodiments, the primary coating 54 may have a thickness in the range of 12-25 microns, or in the range of 12-22 microns, or in the range of 12-19 microns. In one or more embodiments, the secondary coating 56 may have a thickness in the range of 10-20 microns, or in the range of 10-18 microns, or in the range of 10-16 microns. In one or more embodiments, the color layer 58 may have a thickness equal to or less than 10 microns, more particularly equal to or less than 8 microns, and more particularly in the range of 2-8 microns.

In one or more embodiments, the optical fiber 20 has an overall fiber diameter D_{f} equal to or less than 210 microns. More specifically, in one or more embodiments, the overall fiber diameter D_{f} may be in the range of 160-210 microns, or in the range of 160-200 microns, or in the range of 160-190 microns, or in the range of 160-180 microns, or in the range of 160-170 microns, or in the range of 170-210 microns, or in the range of 170-200 microns, or in the range of 170-190 microns, or in the range of 170-180 microns, or in the range of 180-210 microns, or in the range of 180-200 microns, or in the range of 180-190 microns.

In one or more embodiments, the primary coating layer 54 has an elastic modulus (also referred to herein as “elastic modulus”) of less than 1 MPa and a T_{g} (glass transition temperature) of less than −20° C., and the secondary coating layer 24 has an elastic modulus of greater than 1500 MPa and a T_{g} of greater than 65° C.

The primary coating 54 may be made of a known primary coating composition. For example, the primary coating composition may have a formulation listed below in Table 2 which is typical of commercially available primary coating composition.

TABLE 2
Primary Coating Composition

| Component | Amount | |
|---|---|---|
| Oligomeric Material | 50.0 | wt % |
| SR504 | 46.5 | wt % |
| NVC | 2.0 | wt % |
| TPO | 1.5 | wt % |
| Irganox 1035 | 1.0 | pph |
| 3-Acryloxypropyl trimethoxysilane | 0.8 | pph |
| Pentaerythritol tetrakis(3-mercapto propionate) | 0.032 | pph |

where the oligomeric material may be prepared from H12MDI, HEA, and PPG4000 using a molar ratio n:m:p=3.5:3.0:2.0, H12MDI is 4,4′-methylenebis(cyclohexyl isocyanate) (available from Millipore Sigma), HEA is 2-hydroxyethylacrylate (available from Millipore Sigma), PPG4000 is polypropylene glycol with a number average molecular weight of about 4000 g/mol (available from Covestro), SR504 is ethoxylated(4)nonylphenol acrylate (available from Sartomer), NVC is N-vinylcaprolactam (available from Aldrich), TPO (a photoinitiator) is (2,4,6-trimethylbenzoyl)-diphenyl phosphine oxide (available from BASF), Irganox 1035 (an antioxidant) is benzenepropanoic acid, 3,5-bis(1,1-dimethylethyl)-4-hydroxythiodi-2,1-ethanediyl ester (available from BASF), 3-acryloxypropyl trimethoxysilane is an adhesion promoter (available from Gelest), and pentaerythritol tetrakis(3-mercaptopropionate) (also known as tetrathiol, available from Aldrich) is a chain transfer agent. The concentration unit “pph” refers to an amount relative to a base composition that includes all monomers, oligomers, and photoinitiators. For example, a concentration of 1.0 pph for Irganox 1035 corresponds to 1 g Irganox 1035 per 100 g combined of oligomeric material, SR504, NVC, and TPO.

The secondary coating 56 may be made of a known secondary coating composition. The secondary coating may be prepared from a composition that exhibits high elastic modulus. Higher values of elastic modulus may represent improvements that make the secondary coating prepared for the coating composition better suited for small diameter optical fibers. More specifically, the higher values of elastic modulus enable use of thinner secondary coatings on optical fibers without sacrificing performance. Thinner secondary coatings reduce the overall diameter of the optical fiber and provide higher fiber counts in cables of a given cross-sectional area. The elastic modulus of secondary coatings prepared as the secondary coating composition may be equal to or greater than 1500 MPa, more particularly about 1800 MPa or greater, or about 2100 MPa or greater and about 2800 MPa or less or about 2600 MPa or less. The results of tensile property measurements prepared from various curable secondary compositions are listed below in Table 3.

TABLE 3
Tensile Properties of Secondary Coatings

| | Elastic Modulus |
|---|---|
| Composition | (MPa) |
| KB | 1703 |
| A | 2049 |
| SB | 2532 |

A representative curable secondary coating composition is listed below in Table 4.

TABLE 4
Secondary Coating Composition

| | Composition |
|---|---|
| Component | KB |
| SR601 (wt %) | 30.0 |
| SR602 (wt %) | 37.0 |
| SR349 (wt %) | 30.0 |
| Irgacure 1850 (wt %) | 3.0 |

SR601 is ethoxylated (4) bisphenol A diacrylate (a monomer). SR602 is ethoxylated (10) bisphenol A diacrylate (a monomer). SR349 is ethoxylated (2) bisphenol A diacrylate (a monomer). Irgacure 1850 is bis(2,6-dimethoxybenzoyl)-2,4,4-trimethylpentylphosphine oxide (a photoinitiator).

Secondary coating compositions (A) and (SB) are listed in Table 5.

TABLE 5
Secondary Coating Compositions

Composition

| Component | A | SB |
|---|---|---|
| PE210 (wt %) | 15.0 | 15.0 |
| M240 (wt %) | 72.0 | 72.0 |
| M2300 (wt %) | 10.0 | — |
| M3130 (wt %) | — | 10.0 |
| TPO (wt %) | 1.5 | 1.5 |
| Irgacure 184 (wt %) | 1.5 | 1.5 |
| Irganox 1035 (pph) | 0.5 | 0.5 |
| DC-190 (pph) | 1.0 | 1.0 |

PE210 is bisphenol-A epoxy diacrylate (available from Miwon Specialty Chemical, Korea), M240 is ethoxylated (4) bisphenol-A diacrylate (available from Miwon Specialty Chemical, Korea), M2300 is ethoxylated (30) bisphenol-A diacrylate (available from Miwon Specialty Chemical, Korea), M3130 is ethoxylated (3) trimethylolpropane triacrylate (available from Miwon Specialty Chemical, Korea), TPO (a photoinitiator) is (2,4,6-trimethylbenzoyl)diphenyl phosphine oxide (available from BASF), Irgacure 184 (a photoinitiator) is 1-hydroxycyclohexyl-phenyl ketone (available from BASF), Irganox 1035 (an antioxidant) is benzenepropanoic acid, 3,5-bis(1,1-dimethylethyl)-4-hydroxythiodi-2,1-ethanediyl ester (available from BASF). DC190 (a slip agent) is silicone-ethylene oxide/propylene oxide copolymer (available from Dow Chemical). The concentration unit “pph” refers to an amount relative to a base composition that includes all monomers and photoinitiators. For example, for secondary coating composition A, a concentration of 1.0 pph for DC-190 corresponds to 1 g DC-190 per 100 g combined of PE210, M240, M2300, TPO, and Irgacure 184.

The clastic modulus of the secondary coatings 56 made from compositions A, KB and SB were measured using the measurement techniques described below.

In particular, the curable secondary coating compositions were cured and configured in the form of cured rod samples for measurement of elastic modulus, tensile strength at yield, yield strength, and elongation at yield. The cured rods were prepared by injecting the curable secondary composition into Teflon® tubing having an inner diameter of about 0.025″. The rod samples were cured using a Fusion D bulb at a dose of about 2.4 J/cm² (measured over a wavelength range of 225-424 nm by a Light Bug model IL390 from International Light). After curing, the Teflon® tubing was stripped away to provide a cured rod sample of the secondary coating composition. The cured rods were allowed to condition for 18-24 hours at 23° C. and 50% relative humidity before testing. Elastic modulus was measured using a Sintech MTS Tensile Tester on defect-free rod samples with a gauge length of 51 mm, and a test speed of 250 mm/min.

Tensile properties were measured according to ASTM Standard D882-97. The properties were determined as an average of at least five samples, with defective samples being excluded from the average.

The results show that secondary coatings prepared from compositions KB, A, and SB have clastic moduli higher than 1500 MPa. Secondary coatings with high clastic modulus as disclosed herein may be better suited for small diameter optical fibers. More specifically, a higher elastic modulus enables use of thinner secondary coatings on optical fibers, thereby enabling smaller fiber diameters without sacrificing performance. Thinner secondary coatings reduce the overall diameter of the optical fiber and provide higher fiber counts in cables of a given cross-sectional area.

Advantageously, an optical fiber 20 constructed as described above has several beneficial thermomechanical and optical properties as discussed below.

In terms of optical properties, coupling losses can be reduced by providing optical fibers with a mode field diameter that is matched to standard single mode fiber. In one or more embodiments, the optical fiber 20 is compliant with ITU-G.652.D and ITU-G.657.A2 specifications. Further, in one or more embodiments, the optical fiber 20 has a mode field diameter (MFD) at 1310 nm of at least 9 microns, or at least 9.1 microns, or at least 9.2 microns.

In one or more embodiments, the optical fiber 20 exhibits a cabled cutoff of less than 1260 nm and a zero dispersion wavelength of between 1300 nm and 1324 nm.

In one or more embodiments, the optical fiber 20 experiences a bend loss of less than 0.5 dB/turn at 1550 nm for one bend around a mandrel of diameter of 15 mm. In one or more embodiments, the optical fiber 20 experiences a bend loss of less than 0.1 dB/turn at 1550 nm for one bend around a mandrel of diameter of 20 mm. In one or more embodiments, the optical fiber 20 experiences a bend loss of less than 0.003 dB/turn at 1550 nm for one bend around a mandrel of diameter of 30 mm.

### Examples

Exemplary embodiments of optical fibers 20 (Examples 1-4) that can be incorporated into a high fiber density optical fiber cable are provided in Table 6, below. Examples 1˜4 have triangular trenches (as shown in FIG. 16) with trench volumes between 30% Δ-μm² and 60% Δ-μm², MFD at 1310 nm of 9.1 microns or greater, zero dispersion wavelength between 1300 nm and 1324 nm, cable cutoff of less than 1260 nm, bend loss at 1550 nm for 15 mm mandrel diameter of less than or equal to 0.5 dB/turn, bend loss at 1550 nm for 20 mm mandrel diameter of less than or equal to 0.1 dB/turn and bend loss at 1550 nm for 30 mm mandrel diameter of less than or equal to 0.0034 dB/turn.

TABLE 6
Refractive Index Profile Parameters and Optical Properties
of Optical Fibers having Triangular Trenches

| | Example 1 | Example 2 | Example 3 | Example 4 |
|---|---|---|---|---|
| Maximum Core Index, Δ₁ₘₐₓ (%) | 0.336 | 0.37 | 0.332 | 0.385 |
| Core Radius, R₁ (microns) | 4.2 | 5.3 | 4.55 | 5.65 |
| Core alpha | 12 | 2.2 | 12 | 2.12 |
| First Cladding Index, Δ₂ (%) | 0 | 0 | 0 | 0 |
| First Cladding Radius, R₂ (microns) | 7.16 | 7.45 | 9.46 | 8.3 |
| Second Cladding (Trench) Shape | Triangular | Triangular | Triangular | Triangular |
| Second Cladding Min. Index, Δ_{3, min} (%) | −0.5 | −0.55 | −0.33 | −0.28 |
| Second Cladding Radius, R₃ (micron) | 15.9 | 14.9 | 18.9 | 16.6 |
| Volume of Second Cladding (Trench) | −56.9 | −50.94 | −49.05 | −30 |
| Region, V₃, (% Δ-μm²) | | | | |
| Third Cladding Index, Δ4 (%) | 0 | 0 | 0 | 0 |
| Third Cladding Radius, R₄ (microns) | 62.5 | 62.5 | 62.5 | 62.5 |
| Mode Field Diameter (micron) at 1310 nm | 9.1 | 9.1 | 9.23 | 9.18 |
| Zero Dispersion Wavelength (nm) | 1314 | 1319 | 1317 | 1321 |
| Dispersion at 1310 nm (ps/nm/km) | −0.36 | −0.837 | −0.644 | −1 |
| Dispersion Slope at 1310 nm (ps/nm2/km) | 0.090 | 0.093 | 0.092 | 0.0909 |
| Mode Field Diameter (micron) at 1550 nm | 10.21 | 10.22 | 10.34 | 10.41 |
| Dispersion at 1550 nm (ps/nm/km) | 18.32 | 18.27 | 18.2 | 17.61 |
| Dispersion Slope at 1550 nm (ps/nm2/km) | 0.064 | 0.065 | 0.065 | 0.063 |
| Cabled Cutoff (nm) | 1226 | 1204 | 1213 | 1217 |
| Bend Loss for 15 mm mandrel diameter | 0.093 | 0.123 | 0.1611 | 0.199 |
| at 1550 nm (dB/turn) | | | | |
| Bend Loss for 20 mm mandrel diameter | 0.023 | 0.113 | 0.0255 | 0.044 |
| at 1550 nm (dB/turn) | | | | |
| Bend Loss for 30 mm mandrel diameter | 0.0025 | 0.0034 | 0.0032 | 0.0024 |
| at 1550 nm (dB/turn) | | | | |

Table 7 provides examples of optical fibers 20 having rectangular trenches (as shown in FIG. 15) with trench volumes between 30% A-μm² and 60% Δ-μm², MFD at 1310 nm of 9.1 microns or greater, zero dispersion wavelength between 1300 nm and 1324 nm, cable cutoff of less than 1260 nm, bend loss at 1550 nm for 15 mm mandrel diameter of less than or equal to 0.5 dB/turn, bend loss at 1550 nm for 20 mm mandrel diameter of less than or equal to 0.1 dB/turn and bend loss at 1550 nm for 30 mm mandrel diameter of less than or equal to 0.0034 dB/turn.

TABLE 7
Refractive Index Profile Parameters and Optical Properties
of Optical Fibers having Rectangular Trenches

| | Example 5 | Example 6 | Example 7 | Example 8 |
|---|---|---|---|---|
| Maximum Core Index, Δ₁ₘₐₓ (%) | 0.337 | 0.337 | 0.332 | 0.337 |
| Core Radius, R₁ (microns) | 4.55 | 4.6 | 4.55 | 4.5 |
| Core alpha | 12 | 12 | 12 | 12 |
| First Cladding Index, Δ₂ (%) | 0 | 0 | 0 | 0 |
| First Cladding Radius, R₂ (microns) | 10.6 | 10.42 | 10.9 | 10.2 |
| Second Cladding (Trench) Shape | Rectangular | Rectangular | Rectangular | Rectangular |
| Second Cladding Min. Index, Δ₃, min (%) | −0.4 | −0.2 | −0.2 | −0.4 |
| Second Cladding Radius, R₃ (micron) | 15.75 | 17 | 18.9 | 13.4 |
| Volume of Second Cladding (Trench) | −54.28 | −36.72 | −48.44 | 32 |
| Region, V₃, (% Δ-μm²) | | | | |
| Third Cladding Index, Δ4 (%) | 0 | 0 | 0 | 0 |
| Third Cladding Radius, R₄ (microns) | 62.5 | 62.5 | 62.5 | 62.5 |
| Mode Field Diameter (micron) at 1310 nm | 9.172 | 9.19 | 9.23 | 9.17 |
| Zero Dispersion Wavelength (nm) | 1311 | 1315 | 1313 | 1309 |
| Dispersion at 1310 nm (ps/nm/km) | −0.092 | −0.46 | −0.28 | 0.09 |
| Dispersion Slope at 1310 nm (ps/nm2/km) | 0.092 | 0.092 | 0.092 | 0.091 |
| Mode Field Diameter (micron) at 1550 nm | 10.4 | 10.4 | 10.42 | 10.3 |
| Dispersion at 1550 nm (ps/nm/km) | 18.2 | 18.2 | 18.2 | 18.2 |
| Dispersion Slope at 1550 nm (ps/nm2/km) | 0.065 | 0.065 | 0.065 | 0.066 |
| Cabled Cutoff (nm) | 1253 | 1205 | 1215 | 1220 |
| Bend Loss for 15 mm mandrel diameter | 0.093 | 0.2947 | 0.1408 | 0.41 |
| at 1550 nm (dB/turn) | | | | |
| Bend Loss for 20 mm mandrel diameter | 0.04 | 0.0295 | 0.022 | 0.149 |
| at 1550 nm (dB/turn) | | | | |
| Bend Loss for 30 mm mandrel diameter | 0.0011 | 0.003 | 0.0027 | 0.0034 |
| at 1550 nm (dB/turn) | | | | |

Various modifications and alterations may be made to the examples within the scope of the claims, and aspects of the different examples may be combined in different ways to achieve further examples. Accordingly, the true scope of the claims is to be understood from the entirety of the present disclosure in view of, but not limited to, the embodiments described herein.

It will be apparent to those skilled in the art that various modifications and variations can be made without departing from the spirit or scope of the claims.

What is claimed is:

1. A lumen, comprising
a plurality of optical fibers, each of the plurality of optical fibers having an outer diameter of 210 microns or less;
a membrane surrounding the plurality of optical fibers;
wherein a thickness of the membrane is 50 microns or less; and
wherein a free space within the membrane is 50% or less.

2. The lumen of claim 1, wherein the membrane comprises a polypropylene, a polyester, a polyethylene, a polyamide, or a polytetrafluoroethylene material.

3. The lumen of claim 1, wherein the plurality of optical fibers comprises at least two optical fibers.

4. The lumen of claim 1, wherein each of the plurality of optical fibers has a mode field diameter at 1310 nm of larger than 9 microns, a cable cutoff of less than 1260 nm, a zero dispersion wavelength between 1300 nm and 1324 nm, and a bend loss at 1550 nm of less than 0.5 dB/turn for a mandrel diameter of 15 mm.

5. A lumen bundle, comprising:
a plurality of lumens, each lumen comprising:
a plurality of optical fibers, each of the plurality of optical fibers having an outer diameter of 210 microns or less;
a membrane surrounding the plurality of optical fibers;
wherein a thickness of the membrane is 50 microns or less; and
wherein a free space within the membrane is 50% or less;
wherein the plurality of lumens are stranded.

6. The lumen bundle of claim 5, wherein the plurality of lumens are SZ stranded.

7. The lumen bundle of claim 6, wherein the plurality of optical fibers is from 48 to 864 optical fibers.

8. An optical fiber cable, comprising:
a cable jacket comprising an inner surface and an outer surface, wherein the inner surface defines a central cable bore and the outer surface defines an outermost surface of the optical fiber cable;
a lumen bundle disposed within the central bore of the cable jacket, the lumen bundle comprising:
a plurality of lumens, each lumen comprising:
a plurality of optical fibers, each of the plurality of optical fibers having an outer diameter of 210 microns or less;
a membrane surrounding the plurality of optical fibers;
wherein a thickness of the membrane is 50 microns or less; and
wherein a free space within the membrane is 50% or less;
wherein the plurality of lumens are SZ-stranded.

9. The optical fiber cable of claim 8, wherein the plurality of optical fibers are SZ-stranded into first groups of optical fibers comprising from eight to twenty-four optical fibers.

10. The optical fiber cable of claim 8, wherein the membrane comprises a polypropylene, a polyester, a polyethylene, a polyamide, or a polytetrafluoroethylene.

11. The optical fiber cable of claim 8, wherein the outer surface of the cable jacket defines a cross-sectional area of the optical fiber cable and wherein the plurality of the optical fibers divided by the cross-sectional area equals a fiber density of at least 7.5 fibers/mm².

12. The optical fiber cable of claim 11, wherein the plurality of optical fibers is from 48 to 864 optical fibers.

13. The optical fiber cable of claim 8, wherein the plurality of optical fibers have an outer diameter of 190 microns or less.

14. The optical fiber cable of claim 8, wherein each lumen comprises at least 8 optical fibers contained within the membrane.

15. The optical fiber cable of claim 8, further comprising a yarn in each lumen that is color-coded for distinguishing each lumen of the plurality of lumens.

16. The optical fiber cable of claim 8, further comprising at least one strength element embedded in the cable jacket.

17. The optical fiber cable of claim 8, wherein each lumen of the plurality of lumens comprises a cross-sectional area, wherein the cross-sectional area is reconfigurable between a plurality of shapes within the central cable bore.

18. The optical fiber cable of claim 16, further comprising an armor layer between the jacket and the lumen bundle.

19. The optical fiber cable of claim 18, further comprising a protective layer between the armor layer and the lumen bundle.

20. The optical fiber cable of claim 19, wherein the protective layer comprises an extruded foam material.
